(19) United States
(12) Patent Application Publication
(10) Pub. No.: US 2022/0028004 A1
(43) Pub. Date: Jan. 27, 2022

(54) Financial planning system with automated selection of financial products

(71) Applicants: Arthur M. Berd, Sunny Isles Beach, FL (US); Rohit M. D'Souza, New York, NY (US)

(72) Inventors: Arthur M. Berd, Sunny Isles Beach, FL (US); Rohit M. D'Souza, New York, NY (US)

(73) Assignee: WT IP Holdings, LLC, New York, NY (US)

(21) Appl. No.: 17/492,538

(22) Filed: Oct. 1, 2021

Related U.S. Application Data
(63) Continuation-in-part of application No. 16/731,021, filed on Dec. 30, 2019.
Application No. 16/731,021 is a continuation-in-part of application No. 15/960,637, filed on Apr. 24, 2018.
(60) Provisional application No. 62/878,782, filed on Jul. 26, 2019.
(60) Provisional application No. 62/547,786, filed on Aug. 19, 2017.
(60) Provisional application No. 63/087,009, filed on Oct. 2, 2020.

(51) Int. Cl. G06Q 40/06; G06Q 50/18; G06Q 40/02

(52) U.S. Cl. CPC G06Q 40/06; G06Q 40/08; G06Q 40/025; G06Q 50/186

(57) ABSTRACT

A financial planning system automatically chooses financial products, such as insurance or annuities, for an individual's financial plan or financial strategy. The financial planning system can automatically purchase financial products on behalf of the individual. Reduced (anonymized) versions of the financial plans are automatically analyzed to create financial product demand curves by product type, and these demand curves are respectively sent to financial product providers, to encourage commercial offers in accordance with the individuals' financial plans or financial strategies. The financially planning system automatically detects the possibility of bankruptcy during simulations and automatically tries to prevent it via expense reduction, expense elimination, emergency general loan(s) and/or asset liquidation.

### CROSS-REFERENCE TO RELATED APPLICATIONS

This application is a continuation in part of U.S. patent application Ser. No. 16/731,021, filed Dec. 30, 2019, which is a continuation in part of U.S. patent application Ser. No. 15/960,637, filed Apr. 24, 2018, and claims priority to U.S. provisional patent application Ser. No. 62/878,782, filed Jul. 26, 2019, having common inventors herewith, and a common assignee herewith, the disclosures of which are hereby incorporated by reference. This application also claims priority to U.S. provisional patent application Ser. No. 63/087,009, filed Oct. 2, 2020, having common inventors herewith, and a common assignee herewith, the disclosure of which is hereby incorporated by reference.

### BACKGROUND OF THE INVENTION

The present invention relates to a financial planning system that automatically selects financial products in accordance with goals in a financial plan of an individual.

### Conventional Financial Planning Systems

A financial planner advises his or her client as to how to invest to achieve their financial goals. Computer-based systems exist that automate the calculations and projections typically made by a financial planner.

FIG. 1 shows configurations for a conventional financial planning (CFP) system.

A solo financial planner may execute software on their personal computer 50, and may use Internet 10 to access client accounts at banks 20 or brokerages 30. The financial planner may use information service 40 to obtain, e.g., quotes for current market valuation of client investments.

Alternatively, a solo financial planner having personal computer 50, with locally stored client information 55, can use a CFP system operative at financial planning server 60. Instead of a personal computer, the financial planner can use a tablet computer or a smartphone. Typically, personal computer 50 uses a public network, such as Internet 10, to communicate with server 60. In one configuration, referred to as software-as-a-service (SaaS), personal computer 50 has an operating system and browser, but lacks special software. In another configuration, referred to as a client-server configuration, personal computer 50 must first download special client software, and must execute this client software to gain access to the program at financial planning server 60.

An employee financial planner typically uses personal computer 70 on the premises of their employer, which operates financial planning server 60. Local area network (LAN) 62 provides the physical connection from personal computer 70 to financial planning server 60. The client information is stored in storage device 75 that is connected to LAN 62. Financial planning server 60 may use the Internet to access client accounts at banks or brokerages.

Alternatively, an employee financial planner can use financial planning server 60 in a SaaS or client-server configuration.

CFP software can be characterized as goal-based (CFP-GB), cash-flow-based (CFP-CF), or hybrid (CFP-HY).

In a goal-based system, the CFP-GB system explicitly allocates certain funds towards achieving a particular goal and then projects whether the goal can be achieved under simulations. Goals are funded separately, and the likelihood of their achievement is evaluated based on a Monte Carlo analysis of investments dedicated towards each goal. In a purely goal based system, there is no accounting of incomes and expenses, but instead there is an assumption about a level of necessary savings needed to achieve the set goals. The household's actual cash flows remain to be determined by the advisor in a separate exercise to see if the savings can be achieved.

The outcome of the CFP-GB system is a goal-based financial plan (FP-GB), which outlines how much ongoing savings in total are required in order to achieve the customer's goals and how these savings should be apportioned across the goals, and what allocation of investment products is recommended for investing these savings towards the goals.

FIG. 2A is a graph showing a single goal CFP-GB account. Assume that the goal involves one-time spending of a fixed amount, such as a piece of jewelry. Curve A shows the savings per period that the client expects to add to the goal account. Curve B shows the cumulative investment return on the savings in the account. Curve C shows that all of the money in the account is spent on the goal. Curve D shows the balance in the account: savings+return on investment−spending.

FIG. 2B is a graph showing three accounts for three goals in a CFP-GB system, such as home purchase, college tuition for one child, retirement nest egg, and boat. Each account behaves as in FIG. 2A. Importantly, the accounts are maintained independently.

During system set-up (not shown), the financial planning system is configured with tax tables, so that a client's estimated taxes can be automatically computed, and with expected life tables, so that years of retirement can be estimated.

FIG. 2C is a flowchart showing client set-up in a CFP-GB system.

At step 105, the user, either a financial planner acting on behalf of his/her client, or the client him/herself, opens an account for the client, and populates it with the client's age. The system then looks up the client's expected life, subtracts the user's age, and determines the timeframe T for the financial plan, in months, from the present month until the client's expected end of life. The user provides an initial savings balance (ISB) for the client, an expected monthly savings amount for each month, and a set of goal amounts G$[g], g=1 . . . G, and corresponding goal end dates GT[g].

At step 110, the user identifies the client's accounts with third-party systems, such as banks or brokerages, and provides access (read) and/or alteration permission. Most brokerages are set-up to enable a financial advisor to trade a client's account, but not withdraw funds therefrom.

At step 115, the financial planning system populates the client's account with information from the client's third-party accounts.

At step 120, the financial planning system gets initial values for the market environment for the client's account. Typically, this includes current prices for the financial instruments that the users holds, and might wish to hold, and price history for these financial instruments, to derive volatility per instrument. The market environment may also include future forecasts for returns and risk, if the planning system relies on such forecasts.

FIG. 2D is a flowchart showing operation in a CFP-GB system.

At step 150, the financial planner identifies the investments INV v=1 . . . V that will be used in the financial plan, and their risk parameters. For example, the investments that will be considered may be INV={bond1, bond2, bond3, equity1, equity2, equity3}, where each investment is a mutual fund or exchange-traded fund. Assume that bond1 and equity1 have low risk, bond2 and equity2 have medium risk, and bond3 and equity3 have high risk.

At step 155, the financial planning system pre-computes a set of Monte Carlo simulations, to create a Scenario Investment Return array SIR[n,t,v] based on the number of scenarios n=1 . . . N, where N is typically chosen as a large number such as 1,000, but any number may be used so long as it is large enough that the statistical distribution across scenarios is realistic, such as N being at least around 100; the time periods t=1 . . . T, where T was computed at step 105 of FIG. 2C; and the investments v=1 . . . . V chosen at step 150.

The Monte Carlo simulations use random numbers to simulate the behavior of markets. For instance, a low risk investment may be defined to have a monthly return in the range −10% to +10%, a medium risk investment may be defined to have a monthly return in the range −20% to +20%, a high risk investment may be defined to have a monthly return in the range −30% to +30%. The probability distribution for each investment may be defined as Gaussian (bell-shaped), centered at 2% for low risk investments, 6% for medium risk investments, and 12% for high risk investments. For each time period, a pseudo-random number in the range 0 to 1 is generated, with the distribution being equiprobable. Then, the generated number is mapped into a range using the probability distribution appropriate for the type of investment. Other techniques may be used to generate the Scenario Investment Return array SIR[n,t,v], such as a Monte Carlo simulation.

At step 160, the financial planner creates the Goal Accounts, one per goal.

At step 165, the financial planner sets the starting conditions, also referred to as a Trial Financial Plan, by allocating the ISB among the Goal Accounts, setting weights ws[g] for allocating monthly savings S (from step 105 of FIG. 2C) among the Goal Accounts, selecting k=1 . . . K investments for each goal account, and setting the weights w[g,k] for the investments in the Goal Accounts. Table 1 below shows an exemplary Trial Financial Plan, assuming ISB=$100,000.

TABLE 1
Exemplary Trial Financial Plan

| | home | college tuition | retirement | |
|---|---|---|---|---|
| Goal | purchase | for one child | nest egg | boat |
| ISB allocation for | $50,000 | $5,000 | $40,000 | $5,000 |
| goal account | | | | |
| ws[g] | .50 | .15 | .30 | .05 |
| weights for savings S | | | | |
| allocation | | | | |
| investments | equity2 | bond1 | equity2 | equity1 |
| | equity3 | bond2 | bond2 | equity2 |
| | bond1 | bond3 | bond3 | equity3 |
| wI[g,k] | .30 | .20 | .40 | .20 |
| | .10 | .30 | .30 | .20 |
| | .60 | .50 | .30 | .60 |

At step 170, the financial planning system creates the N scenarios based on the Trial Financial Plan and the Scenario Investment Return SIR[n,t,v] from the Monte Carlo simulation. For each scenario, for each time period, for each goal account, the financial planning system system computes the Goal Account Return GAR[n,t,g]:

GAR[n,t,g]=Σₖ₌₁^{K}SIR[n,t,k]*wI[g,k] (equation 1)

and computes the Goal Account balance GA[n,t,g]:

GA[n,t,g]=(1+GAR[n,t,g])*GA[n,t−1,g]+S[t,g] (equation 2)

The financial planning system rebalances the goal account investments to conform to the weighted allocation in the Trial Financial Plan. If the goal's time limit GT[g] has been reached, the financial planning system closes the goal account for the goal, stores the final value of the Goal Account GAFV[n,g]=GA[n,t=GT[g],g], and allocates the savings that would have been used for the goal to other goals by a suitable method such as proportional reallocation or weighted reallocation. In proportional reallocation, each adjusted savings weight ws_adj[g] is increased by the same amount. Assume goal1 (g=1) has been reached, then for g=2 . . . G

ws_adj[g]=ws[g]+ws[1]/(g−1) (equation 3)

In weighted reallocation, each adjusted savings weight ws_adj[g], g=2 . . . G, is increased so that its share of savings remains constant:

ws_adj[g]=ws[g]+ws[g]/Σ_{g=2}^{G}ws[g] (equation 4)

At step 175, the financial planning system determines the goals success likelihood across all scenarios based on the stored GAFV[n,g]. A goal has succeeded when the scenario-wide GAFV[n,g] is at least equal to the goal amount G$[g] specified at step 105 of FIG. 2C. The Heaviside step function 1(⋅) has a value of one for positive arguments and zero for negative arguments.

Goals_success_likelihood=N⁻¹*Σₙ₌₁^{N}1(GAFV[n,g]≥G$[g]) (equation 5)

At step 180, the financial planning system decides whether the Trial Financial Plan is acceptable, that is, whether equation 5 is true for all goals g=1 . . . G. If so, processing continues at step 185. If not, processing returns to step 165, and the financial planner adjusts the Trial Financial Plan.

At step 185, the financial planning system defines the recommended financial plan as the first Trial Financial Plan that was deemed acceptable at step 180.

At step 190, if the customer has given permission, the financial planning system automatically moves funds among accounts, and/or places trades. Fund movement occurs when the ISB is allocated among accounts, when the monthly savings is allocated among accounts, and when accounts are rebalanced to conform to the financial plan.

In a cash-flow-based system, the CFP-CF system is acting more like an accounting system that projects into the future. It computes the planned incomes, expenses, accounts for taxes and other withholdings, and projects a simulated investment portfolio income. The goals in CFP-CF system are also represented as specific cash flow outlays planned for specific times in the future, such as a plan to purchase a second home 5 years from now or a plan to pay for kids' college expenses when they reach 18 years old. The system projects the cash flows and alerts the advisor if there is a deficit or surplus in cash flows under the advisor's financial plan assumptions.

The outcome of the CFP-CF system is a cash-flow-based financial plan (FP-CF), which outlines the parameters of the goals that are achievable given the customer's income and expenses assumptions, as well as the allocation of net savings across investment accounts and across investment products within accounts, recommended in order to achieve the selected goals.

FIG. 3A is a graph separately showing three goals in a CFP-CF system. Curve A shows the calculated savings per period that the client expects to add to the goal account, where savings=income−expenses−taxes. Curve B shows a first goal, with spending over a short time, such as college tuition for one child. Curve C shows a second goal, with one-time spending, such as a jewelry purchase. Curve D shows a third goal with spending over an extended period, such as retirement.

FIG. 3B is a graph showing events in a CFP-CF system. Curves A-D are as above. Curve E shows the cumulative investment return on the savings in the account, note that ater money is spent on a goal, the account balance is reduced so the investment return is calculated on a reduced amount, and thus is smaller. Curve F shows the balance in the account: savings+return on investment−spending.

FIG. 3C is a flowchart showing client set-up in a CFP-CF system.

Step 205 is similar to step 105 of FIG. 2C, except that instead of providing monthly savings S[t], the user provides monthly income INC[t] and monthly expenses EXP[t].

Steps 210, 215 and 220 are similar to steps 110, 115 and 120 of FIG. 2C.

FIG. 3D is a flowchart showing operation in a CFP-CF system.

Steps 250 and 255 are similar to steps 150 and 155 of FIG. 2D.

At step 260, the financial planner selects k=1 . . . K investments for the client's single account, and sets weights w[k] for the investments in the single portfolio account. All goals are funded from this single account. The selected investments k=1 . . . K, and the weights w[k] comprise the Trial Financial Plan.

At step 270, the financial planner set the initial account balance B[t=0] to be the ISB.

At step 275, the financial planning system creates the N scenarios based on the Trial Financial Plan and the Scenario Investment Return SIR[n,t,v] from the Monte Carlo simulation. For each scenario, for each time period, for the single portfolio account, the financial planning system system computes the Net Savings NS[t], where GCF[t,g] represents the goal cash flow spending for goal g at time t:

NS[t]=INC[t]−EXP[t]−TAXES[t]−Σ_{g=1}^{G}GCF[t,g] (equation 6)

then computes the scenario's Portfolio Return PR[n,t]:

PR[n,t]=Σₖ₌₁^{K}SIR[n,t,k]*wI[k] (equation 7)

then computes the account balance B[n,t]

B[n,t]=(1+PR[n,t])*B[n,t−1]+NS[t] (equation 8)

The financial planning system rebalances the goal account investments to conform to the weighted allocation in the Trial Financial Plan, as at step 170 of FIG. 2D. Rebalancing is needed because market growth, regardless of the financial plan, may be different for different investments, causing the portfolio to become imbalanced relative to the desired balance. At the conclusion of the scenario, the financial planning system stores the account balance B[n,t=T].

At step 280, the financial planning system determines the goals success likelihood across all scenarios based on the stored B[n,T]. If B[n,T] is positive, then the scenario is a success.

Goals_success_likelihood=N⁻¹*Σₙ₌₁^{N}1(B[n,T]>0) (equation 9)

At step 285, the financial planning system decides whether the Trial Financial Plan is acceptable, that is, whether the Success_metric is greater than 0. If so, processing continues at step 290. If not, processing returns to step 260, and the financial planner adjusts the Trial Financial Plan.

At step 290, the financial planning system defines the recommended financial plan as the first Trial Financial Plan that was deemed acceptable at step 285.

At step 295, if the customer has given permission, the financial planning system automatically moves funds among accounts, and/or places trades. Fund movement occurs when the ISB is allocated among accounts, when the monthly savings is allocated among accounts, and when accounts are rebalanced to conform to the financial plan.

In a hybrid system, the CFP-HY system is based on goals, like in case of CFP-GB system, however instead of relying on assumption about the level of net savings, it uses a more detailed accounting for cash flows, like in case of CFP-CF system. In a CFP-HY system, all goals are funded together, from the overall net cash flows.

The outcome of the CFP-HY system is a hybrid financial plan (FP-HY), which outlines the recommended levels of net savings (i.e. recommended level of expenses given the customer's income assumptions) together with the parameters of the goals that are achievable given such level of savings, as well as the allocation of net savings across investment accounts and across investment products within accounts, recommended in order to achieve the selected goals.

FIG. 4A is a graph showing a single goal CFP-HY account. Curves A-D of FIG. 4A are similar to curves A-D of FIG. 2A, except that in FIG. 4A, curve A is computed rather than being provided directly by the client or a financial planner, and curve C show a goal that involves spending for a short time, such as college tuition, rather than a one-time spending spike.

FIG. 4B is a graph showing three accounts for three goals in a CFP-HY system. As in a CFP-GB system, each goal has a separately funded goal account. As in a CFP-CF system, the savings allocation for each goal is based on the client's income, expenses and taxes. When a goal's spending has ended, the savings allocation is split among the remaining goal accounts according to a suitable re-allocation method, as discussed above for a CFP-GB system.

FIG. 4C is a flowchart showing client set-up in a CFP-HY system. CFP-HY client set-up steps 305, 310, 315, 320 are similar to CFP-CF setup steps 205, 210, 215, 220, discussed above.

FIG. 4D is a flowchart showing operation in a CFP-HY system.

Steps 350, 355, 360, 365 are similar to steps 150, 155, 160, 165 of FIG. 2D.

Step 370 is similar to step 170 of FIG. 2D, except that at the start of step 370, the net savings is calculated as at step 275, equation 6, of FIG. 3D. Then, the net savings is allocated among goal accounts:

S[t,g]=ws[g]*NS[t] (equation 10)

Steps 375, 380, 385, 380 are similar to steps 175, 180, 185, 190 of FIG. 2D.

There is room for improvement in financial planning systems.

### SUMMARY OF THE INVENTION

In accordance with an aspect of this invention, there is provided a method of creating a best financial strategy for a user, the financial strategy showing how at least one goal is affordable based on the user's income, expenses and investment performance, the financial strategy including at least one automatically selected financial product not associated with the at least one goal. A financial planning computer system stores, in a user database, life actions received from the user, the at least one goal received from the user, the goal being an uncommitted life action, user parameters for at least one financial product chosen by the user, parameters for a wellness metric, and parameters for an acceptability test. The financial planning computer system stores, in a financial products database, financial product offers from financial product providers, each financial product offer having provider parameters and being independent of the at least one user goal.

The financial planning computer system creates a set of financial product scenarios based on the user parameters and the financial product offers; and for each financial product scenario, generates a set of simulations of the user's wealth based on income, expenses, investment performance, goals automatically converted to life actions by the financial planning computer system, and the financial products in the financial product scenario.

The financial planning computer system selects the best financial product scenario according to the parameters for the wellness metric, and checks whether a financial strategy based on the best financial product scenario meets the parameters for the acceptability test; and when the financial strategy meets the parameters for the acceptability test, stores the financial strategy in the user database as the best financial strategy.

In accordance with another aspect of this invention, there is provided a method of creating a best financial strategy for a user that automatically determines when a user's expenses are excessive relative to the user's income and automatically tries to prevent bankruptcy.

A financial planning system receives information for a user including income, expenses, investment strategy and assets. The financial planning system simulates a user's current wealth for N simulation paths based on the user's income, expenses, and investment strategy, each simulation path having T time periods, N being at least 100 and T being at least 60.

At each time period of each simulation path, the financial planning system determines whether the user's current wealth exceeds a solvency threshold.

When the user's current wealth is less than the solvency threshold, the financial planning system automatically takes a prophylactic measure so that the user's current wealth exceeds the solvency threshold.

The financial planning system determines whether the simulations result in the best financial strategy using a wellness metric; and stores the best financial strategy.

In some embodiments, the prophylactic measure is at least one of reducing expenses, eliminating expenses, obtaining a loan, and liquidating assets.

It is not intended that the invention be summarized here in its entirety. Rather, further features, aspects and advantages of the invention are set forth in or are apparent from the following description and drawings.

### BRIEF DESCRIPTION OF THE DRAWINGS

FIG. 1 shows configurations for a conventional financial planning (CFP) system;

FIG. 2A is a graph showing a single goal CFP-GB account;

FIG. 2B is a graph showing three accounts for three goals in a CFP-GB system;

FIG. 2C is a flowchart showing client set-up in a CFP-GB system;

FIG. 2D is a flowchart showing operation in a CFP-GB system;

FIG. 3A is a graph separately showing three goals in a CFP-CF system;

FIG. 3B is a graph showing events in a CFP-CF system.

FIG. 3C is a flowchart showing client set-up in a CFP-CF system;

FIG. 3D is a flowchart showing operation in a CFP-CF system;

FIG. 4A is a graph showing a single goal CFP-HY account;

FIG. 4B is a graph showing three accounts for three goals in a CFP-HY system;

FIG. 4C is a flowchart showing client set-up in a CFP-HY system;

FIG. 4D is a flowchart showing operation in a CFP-HY system;

FIG. 5 shows configurations for a financial planning system according to the present invention;

FIG. 6 is a chart showing prioritized goals with time and cost variability;

FIG. 7 shows a goal with value variability;

FIG. 8A-8H are graphs showing generation of MWAG curves;

FIG. 9 is a flowchart showing system set-up in a financial planning system according to the present invention;

FIG. 10 is a flowchart showing client registration in a financial planning system according to the present invention;

FIGS. 11A-11C are a flowchart showing operation in a financial planning system according to the present invention;

FIG. 12 is a graph showing Monte Carlo simulations of a user's financial life compared to MWAG curves;

FIG. 13 is a chart showing the relationship of the subject matter of this application, and its parent and grandparent applications;

FIG. 14 is a graph showing Monte Carlo simulations of a user's financial life with a bankruptcy simulation;

FIGS. 15A-15B are charts referred to in discussing financial products;

FIG. 16 is a chart showing the conventional process of financial planning;

FIG. 17 is a chart showing financial planning with automatically selected financial products;

FIGS. 18-21 are graphs referred to in explaining automated selection of financial products;

FIG. 22A is a chart showing the deterministic nature of a conventional financial planning system;

FIG. 22B is a chart showing the probabilistic nature of a benchmark financial planning system;

FIG. 23A is a diagram showing the system configuration for a benchmark financial planning system with automatically selected financial products;

FIG. 23B is a flowchart showing system setup for the benchmark financial planning system with automatically selected financial products;

FIG. 23C is a flowchart showing user setup for the benchmark financial planning system with automatically selected financial products;

FIGS. 23D1-23D6 and 23E-23H are a flowchart showing user operation for the benchmark financial planning system with automatically selected financial products;

FIG. 23I is a flowchart showing creation of financing demand curves for the benchmark financial planning system with automatically selected financial products;

FIG. 23J is a flowchart showing loan provider setup for the benchmark financial planning system with automatically selected financial products; and\

FIG. 23K is a flowchart showing loan provider operation for the benchmark financial planning system with automatically selected financial products.

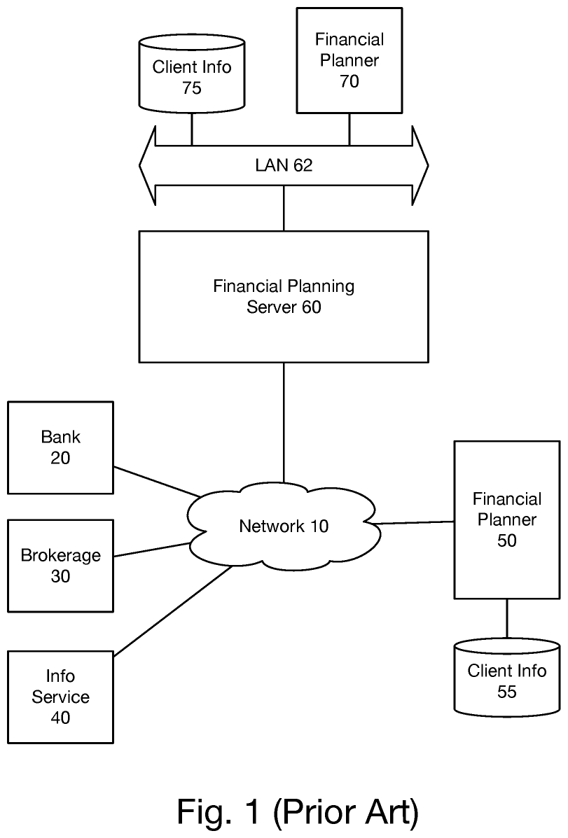

### DETAILED DESCRIPTION

A specific goals/financing financial planning system, also referred to as a consumption planning system, enables connection between an individual's financial plan, and real world product and financing offers that are resources for helping the individual achieve his or her goals.

Only the very richest tier of population has enough wealth and income to be able to manage their financial lives and reach their life goals purely based on the results obtained from investments. For the vast majority of people both in the United States and elsewhere in the world, the bigger portion of their financial lives are centered on ongoing consumption of products and services.

### Financial Planning System (FPS)

Thus, a financial planning system adapted for planning and managing consumption is needed for the rest of the population, so they can understand the implications of their decisions over their lifetimes. A consumption-oriented financial planning system opens the door to aggregating consumption of individuals into a group, obtaining benefits from product and service providers based on the group, and feeding such benefits back to the individuals.

An important aspect of an optimal financial plan is timing. First, it is necessary to model the full cost of consumption, including upfront and periodic costs as well as savings. Second, it is helpful to have consumption priorities so that resources can be optimally allocated. Third, it is helpful to know flexibility in usage and cost.

Optimal wealth management creates more money for consumption. Wealth management comprises properly allocating savings between cash and investments of differing types and differing taxability, and managing risk exposure across different investments.

Optimal consumption management depends on spending limited resources on the things that matter, which is modelled by assigning priorities to goals.

A critical part of a consumption managing system is the ability to choose the best financial products for a user. Accordingly, financial planning systems automating the choice of financial products will now be discussed.

### Financial Product, Also Referred to as Financial Widget (FW)

As used herein and in the claims, a “financial widget” is a two-way financial product wherein a provider accepts a first payment stream from a user, and provides a second payment stream to the user; each payment stream includes one or more payments, and multiple payments may be periodic or non-periodic. The first payment stream may be provided before or after the second payment stream, or they may overlap. When the payments from provider to user occur after an exogenous event, the financial widget is a risk-shifting product. An exogenous event is an event whose occurrence is not controlled by either the provider or the user of the financial widget.

The parent application hereto is concerned with products as instances of goals, and with financing tied to a goal. In this application, such products are referred to as “goal products” to distinguish from financial products, which are not tied to a goal. Generally, financial products are not eligible for financing, while goal products are eligible for financing as the lender can have an interest in the goal product or at least the right to file a lien against the goal product.

### Financial Plan (FP)

A financial plan (FP) is a comprehensive statement of an individual's goals, particularly long-term goals, and a detailed savings and investing election for achieving those goals. The financial plan is highly individualized to reflect the individual's personal and family situation, risk tolerance, and future expectations.

The outcome of a financial plan is a specification of how the individual's savings should be invested to achieve the individual's goals. Goal actions occur when specified by the user, as part of the goals. The conventional financial plan should be recomputed (updated) to reflect changes in the individual's situation and changes in the investment market.

### Financial Strategy (FS)

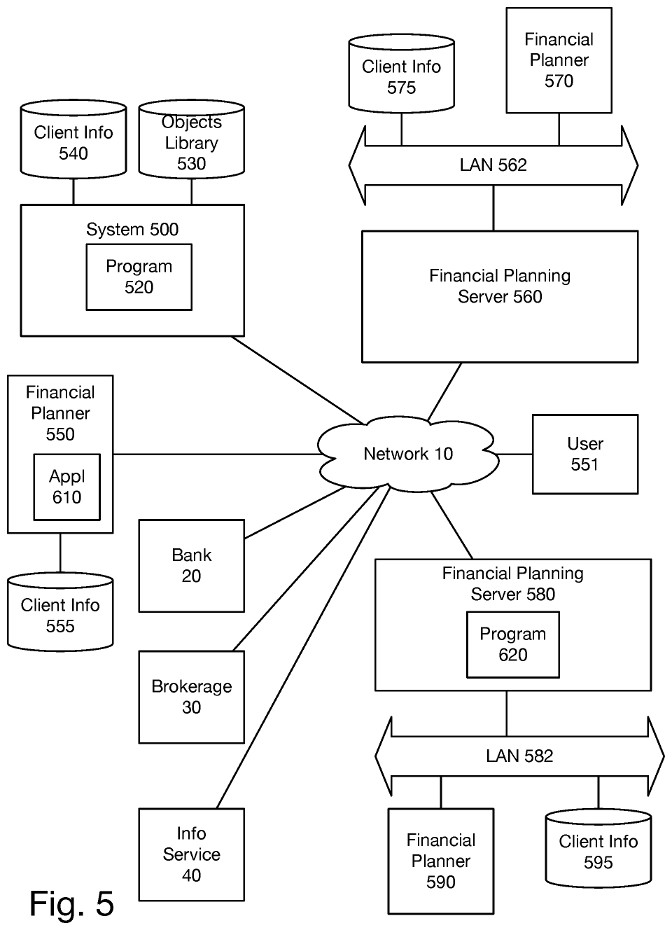

A financial strategy (FS) is created by a benchmark financial planning system (BFPS), see FIGS. 5-12. As a matter of terminology, a FP is created by a conventional FPS or a modified conventional FPS, while a FS is created by a benchmark FPS or a modified benchmark FPS.

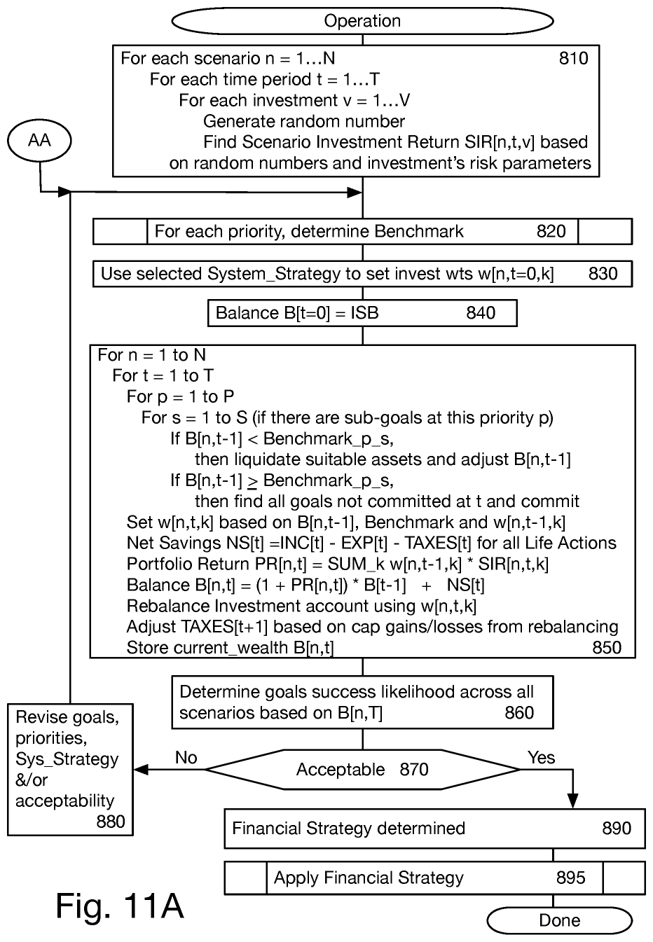

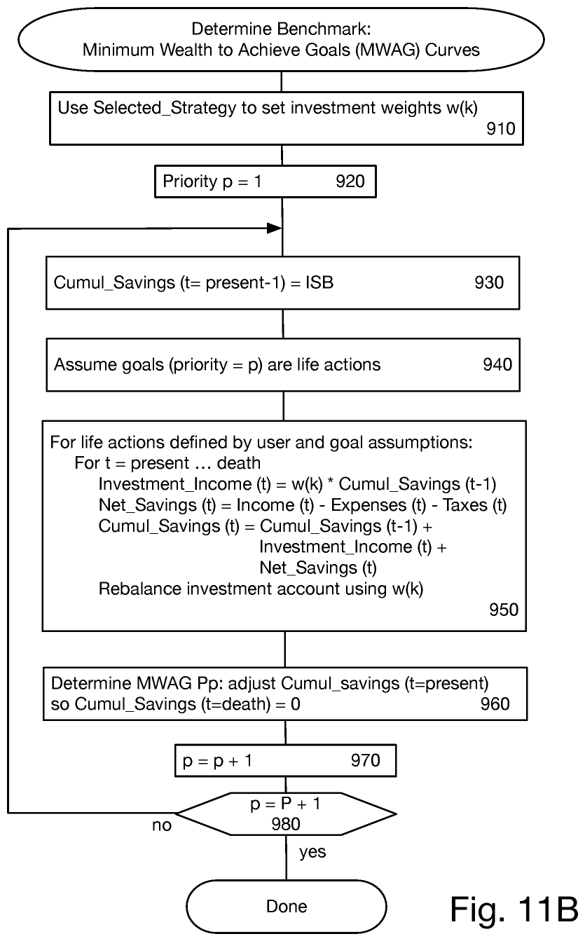

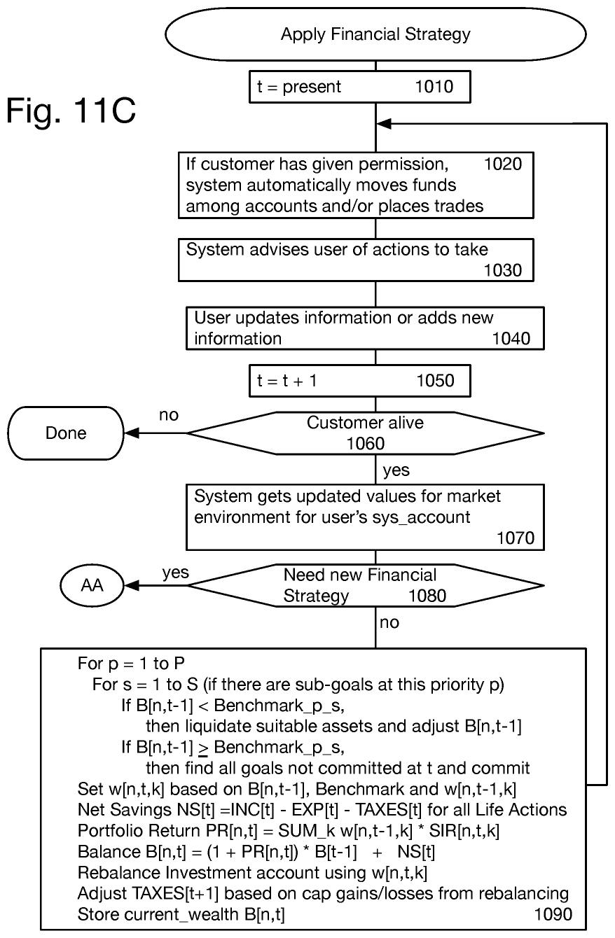

The FS can be thought of as a self-updating FP plus periodic advice, where the self-updates occur due to market changes and user actions: updating information or adding new information, see FIG. 11C step 1040. In contrast, a FP is not self-updating and is not associated with periodic advice.

At explained at FIG. 11A step 890, the FS comprises the parameters leading to goals success likelihood deemed acceptable at step 870. These parameters include the initial savings balance specified at step 720, the life actions specified at step 725, the goals and priority levels specified at step 730, the liquidatable assets specified at step 735, the System_Strategies specified at step 740, the acceptability threshold specified at step 745, and the benchmark curves determined at step 820.

The outcome of a FS is, for each time interval, investment actions and goal actions to take, based on the individual's savings and goals, the individual's previously enacted (or simulated, if in the context of future simulations) investments and goal actions, and changes in the market environment in the previous time interval (see FIG. 11C steps 1020 and 1030).

The FS detects when it needs to be updated to reflect changes in the individual's situation and changes in the investment market, and automatically updates itself (see FIG. 11C step 1080).

### Benchmark Financial Planning System

As used herein and in the claims, a “life action” is an event affecting the user's financial plan; a life action may have a one-time effect or a periodic effect or a combination thereof. Life actions represent the reality of a user's financial life. Examples of life actions include: a salary from a job, an expected inheritance in the future, rent payments to the user's landlord, rental income from the user's properties, and so on.

As used herein and in the claims, a “goal” is an uncommitted life action. Goals represent what the user wants. When a user commits to a goal in her financial plan, the goal becomes a life action. A goal has a cost or range of costs, and has a desired timeframe expressed as a particular start date and a particular duration, or as a range of start dates and a particular duration. Examples of goals include retirement, tuition for the user's child, home purchase, charitable gift or endowment, and so on. A “legacy goal” is a one-time cost that occurs at the user's death, such as leaving an inheritance.

As used herein and in the claims, a “life object” is either a “life action” or a “goal”.

One problem with prior art financial planning systems is that the system tries to fund all goals, which often leads to all goals being unfunded.

An advantage of the present invention is that the financial planning system is able to choose which goals to fund. As the system decides that a goal is affordable, the system changes that goal to “committed”.

A goal is modelled as an initial cost, optionally followed by periodic recurring costs, possibly ending at a particular date. Each goal has a user-specified priority, with higher priority goals being funded before lower priority goals. At least one highest priority goal must be specified. The present system provides templates for modelling goals such as retirement, home purchase, vehicle purchase, vehicle lease, child's college, child's wedding, and a free-form template; the non-free-form templates automatically check “reasonableness” such as requiring that the start date precede the end date.

Another problem with prior art financial planning systems is that all goals are the same priority, which forces the user to manually impose priority, such as by first running the system with highest priority goals, and only after these succeed, can the user move on to other goals. This is inefficient.

Another advantage of the present invention is that the user is able to assign priorities to goals, so the system automatically achieves goals in accordance with the user's priorities, and the user is saved from executing multiple iterations of the system to find out how many goals are achievable.

A further problem with prior art financial planning systems is that goals can be specified only for a fixed duration, and for a particular cost. This is extremely inefficient for a user, since the user must manually figure out what is achievable for goals that can vary in time and/or cost, leading the user to multiple executions of the financial planning system.

A further advantage of the present invention is that the user is able to specify goals having a variable timeframe and/or a variable cost, so the system automatically can be lavish or frugal depending on a simulation outcome and/or a user's goal flexibility.

Yet another problem with prior art financial planning systems is that the investment allocation remains constant over the user's lifetime.

Yet another advantage of the present invention is that the investment allocation may change over a user's lifetime. In one embodiment, the desired investment allocation is defined independent of the user's life actions. In another embodiment, the desired investment allocation changes in response to one or more of the user's age, life actions and total wealth.

The present financial planning system calculates priority-level benchmarks, such as “minimum wealth to achieve goals” (MWAG), based on the goals at each priority level. The benchmarks are a family of curves, with one curve for each goal priority level. The lowest value curve corresponds to the highest priority goal spending. The second lowest value curve corresponds to the highest priority curve plus the second highest priority goal spending. The third lowest value curve corresponds to the second lowest level curve plus the third highest priority goal spending, and so on. In this embodiment, the minimum wealth to achieve goals benchmark assumes that, for a goal having a time range, the goal begins at the latest possible time; and assumes that, for a goal having a value range, the minimum value is used.

If a goal has a range of values, the range values are divided into sub-goals, with a minimum wealth to achieve goals curve for each sub-goal.

For each Monte Carlo scenario, corresponding to one possible future scenario of investment returns, the system chooses which goals to fund based on comparison of the current wealth with the minimum wealth to achieve goals: lower-priority goals are funded only when aggregate wealth is sufficient to fund all higher priority goals. Then, the likelihood of success for each goal is summed across all scenarios.

If these scenarios result in an acceptable plan, and if the user has given permission, the financial planning system then acts on this plan, such as by moving funds among accounts or placing securities trades.

If these scenarios do not result in an acceptable plan, then the user must change his or her goals, or income expectations. Advantageously, the user does not consume time running scenarios with re-ordered existing goals, as the system has already done the best that can be done with the existing goals.

FIG. 5 shows configurations for a financial planning system according to the present invention. Five configurations of the financial planning system are depicted.

Network 10 is any suitable communication network such as the Internet. Financial planning system 500, financial planner 550, financial planning servers 560, 580, bank 20, brokerage 30, information service 40 and user 551 are each coupled to network 10 via a suitable communication channel. Generally, financial planner 550 configures the financial planning system, and then uses the financial planning system on behalf of his client or customer, or enables his client or customer to use the financial planning system directly. User 551 is a client or customer of financial planner 550 that directly uses the financial planning system, as configured by financial planner 550. As used herein, “user” means either financial planner 550 and/or user 551, as will be apparent from context.

First, a solo financial planner may execute planning software 610 on her personal computer 550 having locally stored client information 555, and may use Internet 10 to access client accounts at banks 20 or brokerages 30. The financial planner may use information service 40 to obtain, e.g., quotes for current market valuation of client investments.

Second, in a client-server configuration, a solo financial planner having client planning program 610 (instead of a full planning system) executing on her personal computer 550, with locally stored client information 555, can use financial planning server 500 executing server planning program 520. In a variation, financial planning server 500 enables the financial planner to store her client's information in client information storage 540 coupled to financial planning server 500. Instead of a personal computer, the financial planner can use a tablet computer or a smartphone or other suitable device. Typically, personal computer 550 uses a public network, such as Internet 10, to communicate with server 500.

Life objects library 530 includes goal templates and life action templates. Each template provides fields for financial modelling of that type of goal or life object, including priority, date and cash flow. Examples of life objects include job (periodic salary, periodic bonus, social security earnings), trust fund income, alimony income, expected inheritance, social security payments and life insurance.

In some embodiments, the system suggests financing options such as vehicle loans, mortgage refinancing, good times to buy or sell lower priority life objects such as a second car to achieve higher priority goals.

Third, in a software-as-a-service (SaaS) configuration otherwise similar to the client-server configuration, a solo financial planner uses personal computer 550 has an operating system and browser, but lacks special software; client data can be stored in local storage 555 or in server client storage 540. Instead of a personal computer, the financial planner can use a tablet computer or a smartphone or other suitable device.

Fourth, an employee financial planner uses personal computer 590 on the premises of their employer, which operates financial planning server 580 executing financial planning program 620. Local area network (LAN) 582 provides the physical connection from personal computer 590 to financial planning server 580. The client information is stored in storage device 595 that is connected to LAN 582. Financial planning server 580 may use the Internet to access client accounts at banks or brokerages. Instead of a personal computer, the financial planner can use a tablet computer or a smartphone or other suitable device. Financial planning program 620 operates according to a SaaS configuration; in a variation, financial planning program 620 operates according to a client-server configuration.

In a further variation, the employee financial planner is not on her employer's premises, and uses Internet 10 to communicate with financial planning server 580 executing financial planning program 620.

Fifth, an employee financial planner uses personal computer 570 on the premises of their employer, which operates financial planning server 560. Local area network (LAN) 562 provides the physical connection from personal computer 570 to financial planning server 560. The client information is stored in storage device 575 that is connected to LAN 562. Financial planning server 560 may use the Internet to access client accounts at banks or brokerages. Instead of a personal computer, the financial planner can use a tablet computer or a smartphone or other suitable device.

Financial planning server 560 is essentially a proxy, so that the employee financial planner can use financial planning program 520 executing on financial planning server 500. Financial planning program 520 operates according to a SaaS configuration; in a variation, financial planning program 520 operates according to a client-server configuration, with the client program located at financial planning server 560 or financial planner computing device 570. In a variation, financial planning server 500 enables the financial planner to store her client's information in client information storage 540 coupled to financial planning server 500.

In a further variation, the employee financial planner is not on her employer's premises, and uses Internet 10 to communicate with financial planning server 560.

Each of personal computer 550, 570, 590 and server 500, 560, 580 is a general purpose computer programmed according to the present invention. Connections to Internet 10 may be wireline or wireless.

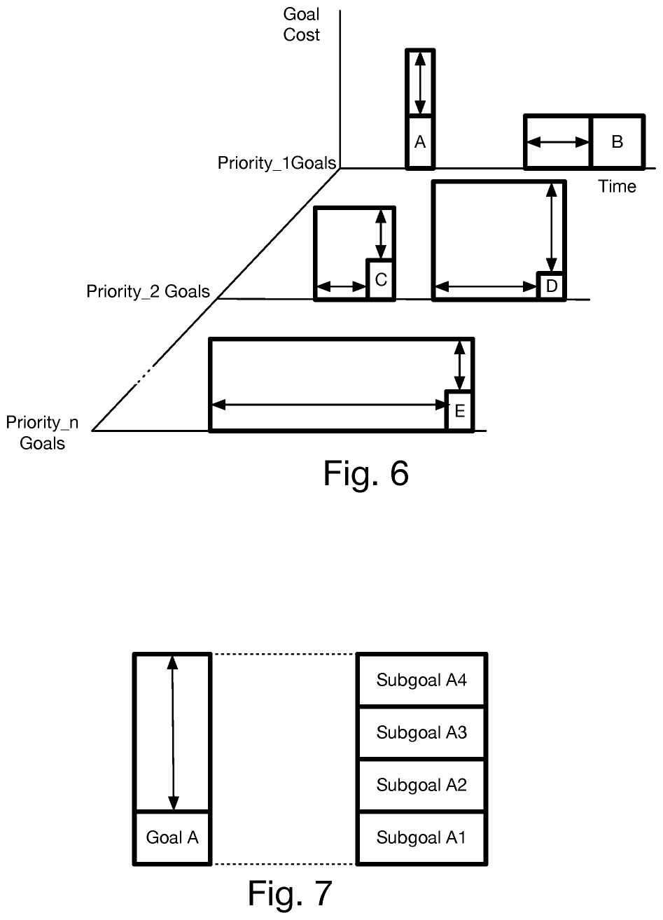

FIG. 6 is a chart showing prioritized goals with time and cost variability. Importantly, the present invention begins by automatically gathering more information from the user than prior art systems. The user can define as many goal priorities as she wishes, with at least one goal at each priority level. Priority 1 goals are the most important, and there must be at least one priority 1 goal.

Each goal has at least a start time, a duration of spending, and an amount spent. The financial planning system has a monthly granulation, that is, the Monte Carlo simulations are performed on a month-by-month basis, so the amount spent per goal can be specified per month of the duration. However, typically the user is interested in a lifetime plan, so the goal spending is specified per year. If the spending needs to change over the duration of the goal, the goal should be defined as two goals at the same priority level, preferably with no other goals at this priority level.

Additionally, the start time of a goal can be specified as a range, and/or the cost of a goal can be specified as a range.

FIG. 6 shows five exemplary goals.

At Priority 1, Goal A, such as college tuition for a child, has a duration of a few years, and a cost specified as a range, corresponding to (a) uncertainty as to future tuition cost and (b) uncertainty as to what percent of tuition that the parent will pay.

Also at Priority 1, Goal B, such as retirement, shows flexibility in start date, with a fixed annual cost.

At Priority 2, Goal C, such as a home downpayment, shows flexibility in start date and in cost, corresponding to the user's desire to own a home but not being picky about when or its type.

Also at Priority 2, Goal D, such as a charitable gift, shows flexibility in start date and in cost, corresponding to the user's desire to gift something appropriate for her future circumstances.

Goals at priorities 3 to (n−1) are not shown.

At Priority (n), Goal E, such as a boat, shows flexibility in start date and in cost. By specifying this as the lowest priority goal, the user indicates that she wants this goal only if she becomes unexpectedly wealthy.

Time variability in a goal will now be discussed.

When a goal has a time range specified for its start date, the benchmark calculation (such as a minimum wealth to achieve goals calculation) assumes that the latest time in the range is the start date of the goal. For each Monte Carlo simulation, time variable goal funding can occur according to different techniques. In one technique, as soon as the user's wealth exceeds the minimum wealth to achieve goals for that goal, it will be funded. In another technique, the latest start date of the goal is always used. A further technique, discussed below, may be used if the goal also has value variability.

Value variability in a goal will now be discussed.

FIG. 7 shows a goal with value variability split into discrete sub-goals. In one embodiment, the user specifies how many sub-goals should be associated with the goal, and the financial planning system evenly divides the range over the number of sub-goals. In another embodiment, the user specifies how many sub-goals and the value of each sub-goal. In a further embodiment, the financial planning system automatically divides each range into a predetermined number of sub-goals, such as three. Other techniques are used in other embodiments.

For each Monte Carlo simulation, variable value goal funding can occur according to different techniques. In one technique, as soon as the user's wealth exceeds the minimum wealth to achieve goals for the lowest value sub-goal, it will be funded. If the goal also has time variability, the following technique may be used: at the soonest time that the least value sub-goal can be funded, the financial planning system estimates the benefit of waiting until the latest time of funding, and if the expected benefit exceeds a predetermined threshold then the financial planning system waits until the earlier of (a) when the highest value sub-goal can be funded, and (b) the latest time of funding, to decide at what time and level to fund this goal.

Creation of benchmark curves will now be discussed.

As used herein and in the claims, a benchmark is a value at a particular time that indicates whether an objective is or is not achievable, with an objective being either one goal or a set of goals having the same priority. The present financial planning system uses benchmarks to choose which user goals to fund.

In this embodiment, a “minimum wealth to achieve goals” (MWAG) technique is used to determine the benchmark curves. In other embodiments, other techniques are used to determine the benchmarks.

A second benchmark technique is to assume the most conservative returns on all investments, then project all cash flows, and via trial and error, adjust the initial starting wealth to achieve the goals at the highest priority level. This process is repeated with goals at the highest and next-highest priority level to achieve the initial starting wealth for the next benchmark. This is repeated for all priority levels to achieve all benchmark curves.

A third benchmark technique is to re-run the entire set of Monte Carlo simulations so that the user's wealth at the time of death is zero.

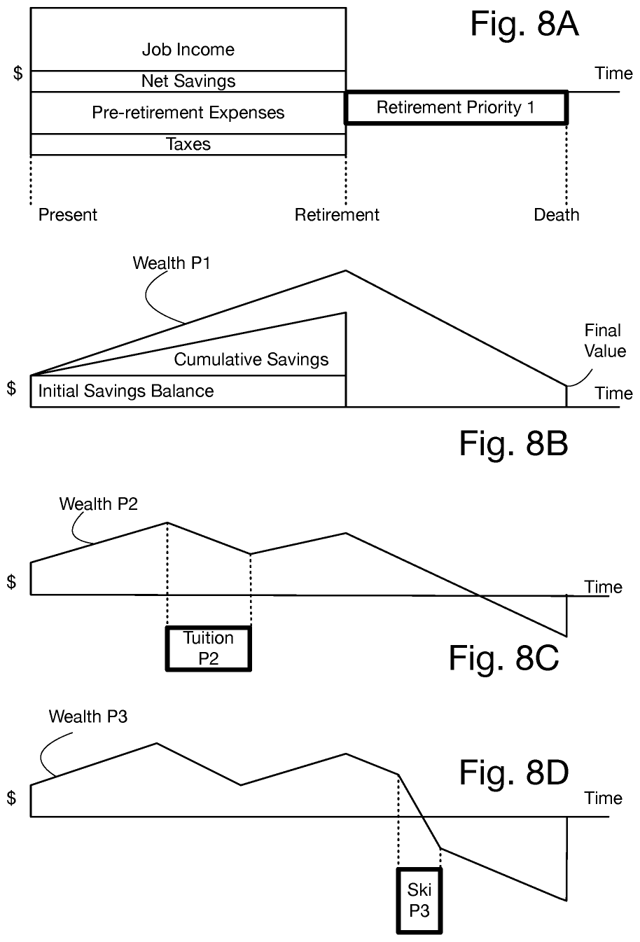

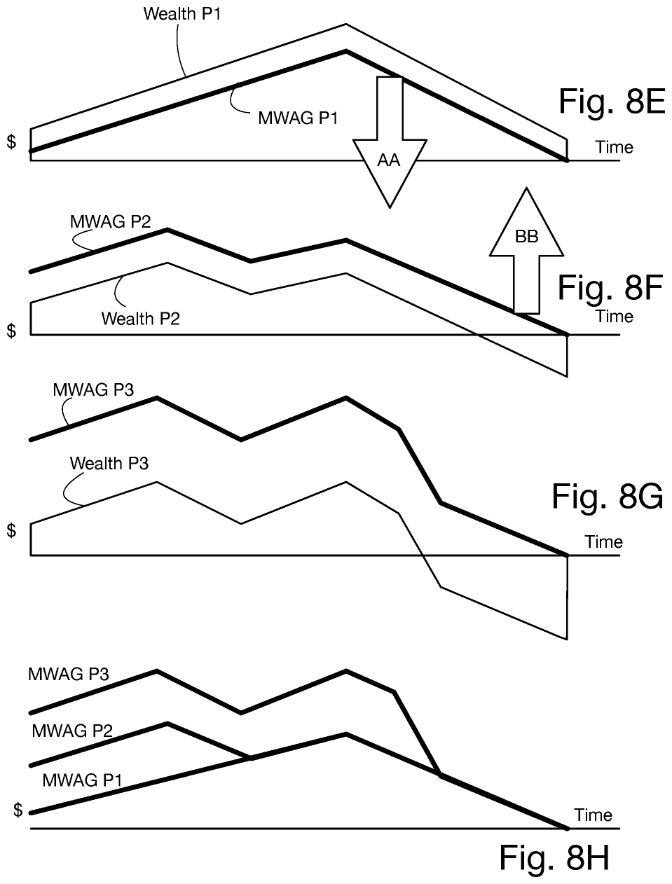

FIG. 8A-8H are graphs showing generation of MWAG curves. FIGS. 8A-8D represent the user's projected hypothetical financial activity, while FIGS. 8E-8H show how MWAG curves are obtained from the hypothetical financial activity.

Assume that the user has one priority 1 goal: retirement; one priority 2 goal: tuition for the user's only child; and one priority 3 goal: multi-country ski trip. During retirement, the user's only expenses are retirement expenses. Assume further that the user has income only from a job and investments.

FIG. 8A shows the user's life actions, and priority 1 goal of retirement, summed to yield total income, total expenses, total taxes and total savings over the user's financial life, beginning at the present and ending at the user's death:

Savings[t,p]=Income[t,p]−Expenses[t,p]−Taxes[t,p] (equation 11)
where t=Present . . . Death
   p=priority level

FIG. 8B shows the user's initial savings balance (ISB), the user's cumulative savings, the user's investment income and the user's hypothetical Wealth over the user's financial life:

Cumulative_Savings[t,p]=Σ_{t=Present}^{Death}Savings[t,p] (equation 12)

Invest_Income[t,p]=Invest_return*(ISB+Cumulative_Savings[t−1,p]) (equation 13)

Wealth[t,p]=ISB+Cumulative_Savings[t,p]+Invest_Income[t,p] (equation 14)

The hypothetical wealth includes investment income that assumes a fixed rate of return for the investments for the planning period, as in conventional financial planning systems. This fixed rate of return may represent the sum of the rates of return of several investments with respectively different rates of return.

In another embodiment, instead of a fixed rate of return for the investments, a set of investment rate of return Monte Carlo simulations is generated for the financial planning period, and the average simulated rate of return at each period is used for the investments.

Final Value[p] refers to the user's wealth at the time of death, Wealth[t=Death, p]. In this case, the ISB and Final Value[p=1] of the Wealth P1 are positive. However, in other cases, the ISB and/or Final Value may be negative. The ISB could be negative if the user owes money (e.g., student loans). The Final Value could be negative if the user is destitute or has her wealth in illiquid assets that are not included in Wealth as defined here.

FIG. 8C shows the effect of adding the priority 2 goals—child's college tuition—to the user's wealth incorporating priority 1 goals, yielding the user's wealth incorporating priority 1 and priority 2 goals, Wealth P2=Wealth P1+goals [p=2]. The user's wealth decreases due to spending on priority 2 goals, so that Final Value [p=2] becomes negative.

FIG. 8D shows the effect of adding the priority 3 goals—ski trip—to the user's wealth incorporating priority 1 and 2 goals, yielding the user's wealth incorporating priority 1, priority 2 and priority 3 goals, Wealth P3=Wealth P2+goals [p=3]. The user's wealth decreases due to spending on priority 3 goals, so that Final Value [p=3] becomes more negative than Final Value [p=2].

FIG. 8E shows MWAG P1 based on Wealth P1. The MWAG curve is approximately the Wealth curve slid up or down along the y-axis (value) such that the Final Value of the MWAG curve is zero. The sliding corresponds to adjusting the Initial Savings Balance, which also affects lifetime Investment Income, explaining why vertical sliding is only an approximation. Any suitable technique may be used to determine the ISB, such as the bisection method or the Newton method.

The bisection method bisects an interval, then selects a subinterval for further processing. In this example, the MWAG curve approximately results from sliding the Wealth curve down, so the bisection method begins with the interval defined by ISB of Wealth P1 and zero, and iterates, generating a “Wealth” curve at each iteration until the Final Value of the “Wealth” curve is within a predetermined threshold, such as 2% of the Final Value of Wealth P1, of zero, and then this “Wealth” curve is the MWAG P1 curve.

The Newton method finds successively better approximations based on adjusting an initial guess by subtracting a function of the initial guess divided by the first derivative of the function of the initial guess to yield a second guess, then iterating by adjusting successive guesses until the Final Value of the “Wealth” curve is within a predetermined threshold, such as 2% of the Final Value of Wealth P1, of zero, and then this “Wealth” curve is the MWAG P1 curve.

FIG. 8F shows the MWAG P2 curve based on the Wealth P2 curve. MWAG P2 is obtained from Wealth P2 in a similar manner as MWAG P1 was obtained from Wealth P1. Note that since the Final Value of Wealth P2 is negative, the Wealth P2 curve is approximately slid upwards to yield the MWAG P2 curve.

FIG. 8G shows the MWAG P3 curve based on the Wealth P2 curve. MWAG P3 is obtained from Wealth P3 in a similar manner as MWAG P1 was obtained from Wealth P1. Note that since the Final Value of Wealth P3 is negative, the Wealth P3 curve is approximately slid upwards to yield the MWAG P3 curve.

FIG. 8H shows the MWAG P1, P2, P3 curves from FIGS. 8E-8G on one graph. The initial point keeps rising, reflecting money needed for goals at successive priority levels. It will be understood that the shape of the MWAG curves is highly dependent on the user's financial activity, that is, life actions and goals.

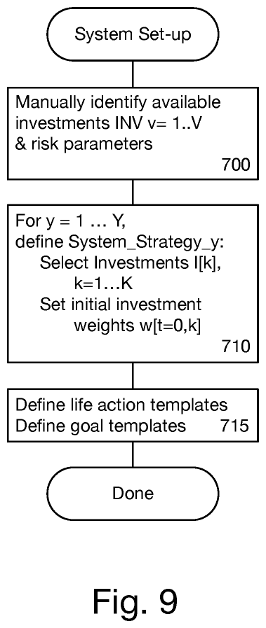

FIG. 9 is a flowchart showing system set-up in a financial planning system according to the present invention. The information created during set-up is stored in a suitable storage, such as client storages 540, 555, 575, 595 and objects library 530, shown in FIG. 5.

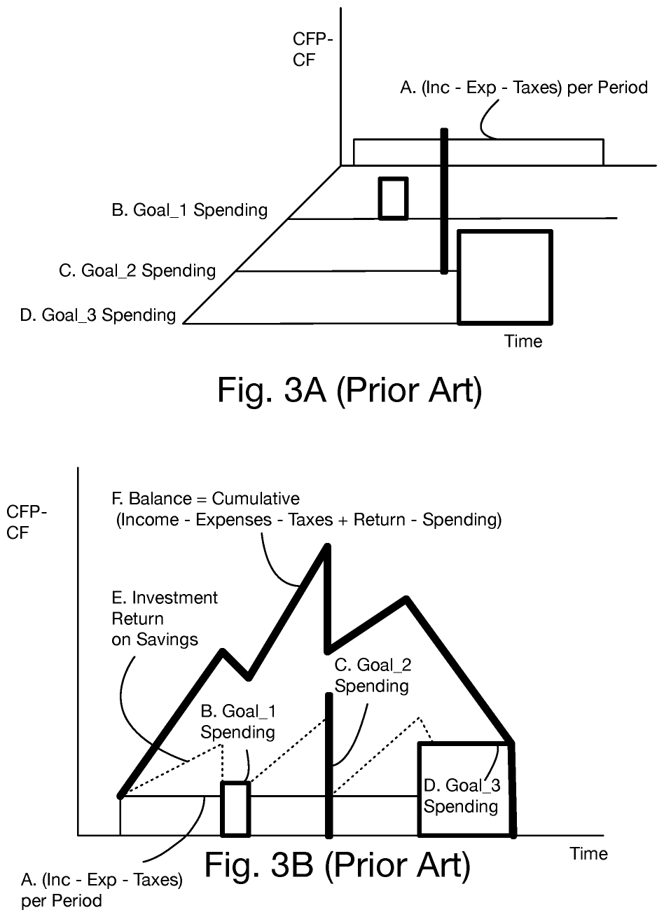

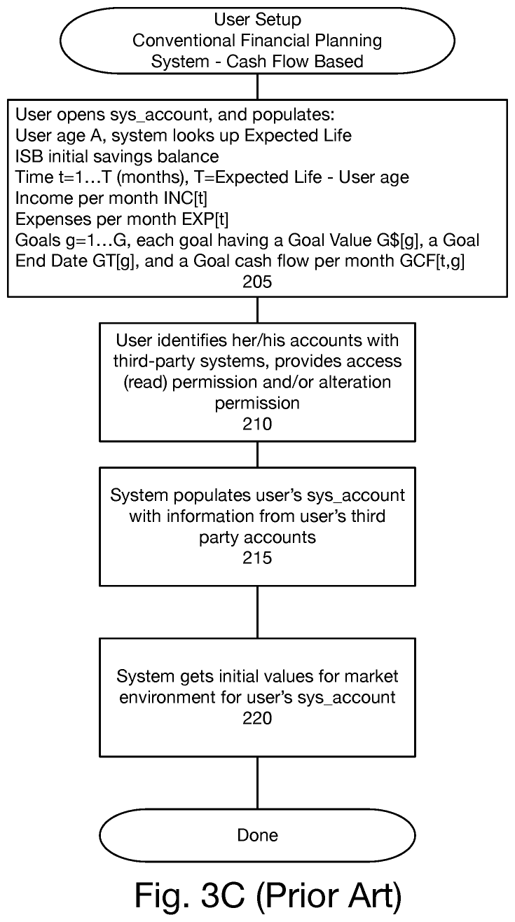

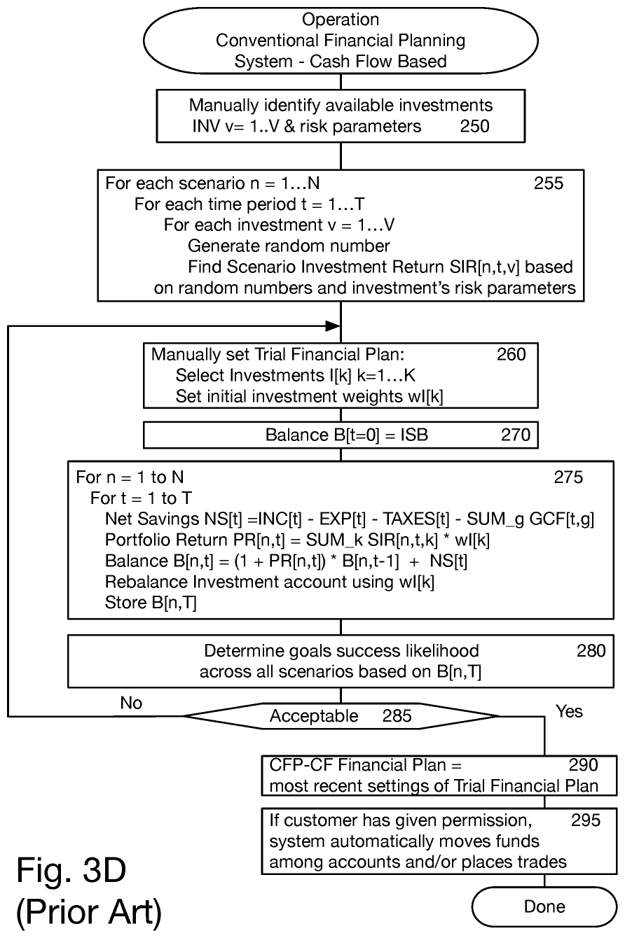

At step 700, the financial planner manually identifies the available investments v=1 . . . V and their associated risk parameters. This is similar to step 250 of FIG. 3D.

At step 710, the financial planner defines up to Y strategies. For each strategy y, y=1 . . . Y, the financial planner selects K investments, and sets the initial investment weights, that is, the portion of savings to be allocated to each investment. Each initial investment weight is a fraction between 0 and 1, with the total of the weights summing to 1.0. For example, if K=3, then the initial investment weights might be [0.330.330.34] for even weighting, or [0.20.20.6] for uneven weighting.

The present system enables the investment allocation to change over time. Typical strategies favor higher risk investments when the client is younger, and lower risk investments when the client is older. A conventional “target date fund” automatically changes the investment allocation of a portfolio based on the time remaining until the target date of the fund; investors are supposed to choose a target date close to their desired retirement. Prior art financial planning systems accommodate target date funds, if at all, via a bundle of predefined scenarios, such as about 50 scenarios, instead of Monte Carlo simulated scenarios.

The present financial planning system essentially customizes a target date fund to the user, rather than requiring the user to pick a fund closest to her needs. The user's retirement date can be flexible, whereas conventional target date funds lack time variability in the target date.

The present financial planning system accommodates target date funds via Monte Carlo simulated scenarios, such as about 1,000 scenarios, with the portfolio weights of investments varying over time, thereby better modelling risk. For instance, assume that the k=1 investment has high risk, the k=2 investment has medium risk and the k=3 investment has low risk, and that t indicates the year of the financial plan (t=0 is the initial condition). The following system investment strategy y(1) changes from high risk to low risk as the client ages: [t=0, 1.0 0 0], [t=10, 0.8 0.2 0], [t=20, 0.5 0.5 0], [t=30, 0.2 0.5 0.3], [t=40, 0 0.3 0.7]. The following system investment strategy y(2) changes from medium to low risk as the client ages: [t=0, 0.3 0.7 0], [t=10, 0.2 0.7 0.1], [t=20, 0.1 0.5 0.4], [t=30, 0 0.3 0.7], [t=40, 0 0 1.0].

In another embodiment, the desired investment allocation changes in response to one or more of the user's age, life actions (goal completion) and total wealth. For example, after the goal of paying for a child's college tuition is met, the user may be willing to assume more risk with their income that had gone towards tuition.

At step 715, the financial planner defines the life object templates, comprising the life action templates and goal templates, to be available to users. A goal template has a field for priority level. A life action template lacks a priority level. Usually, the financial planner selects from a library of life object templates. The financial planner may also create customized life object templates. The life object templates automatically check “reasonableness” such as requiring that the start date precede the end date.

A liquidatable asset is a type of life action.

The life object template has a row for each field. Each row includes a field number, a field status (required or optional), a field name, and a field value supplied by the template creator or by the user. Income fields 8A-8B are comparable to Cash Flow fields 9A-9E, that is, a template that uses Income does not use Cash Flow, while a template that uses Cash Flow does not use Income. A life object template can be configured to represent any of the following:

an expected inheritance life action;

a tuition goal;

a student loan life action;

a rental property life action;

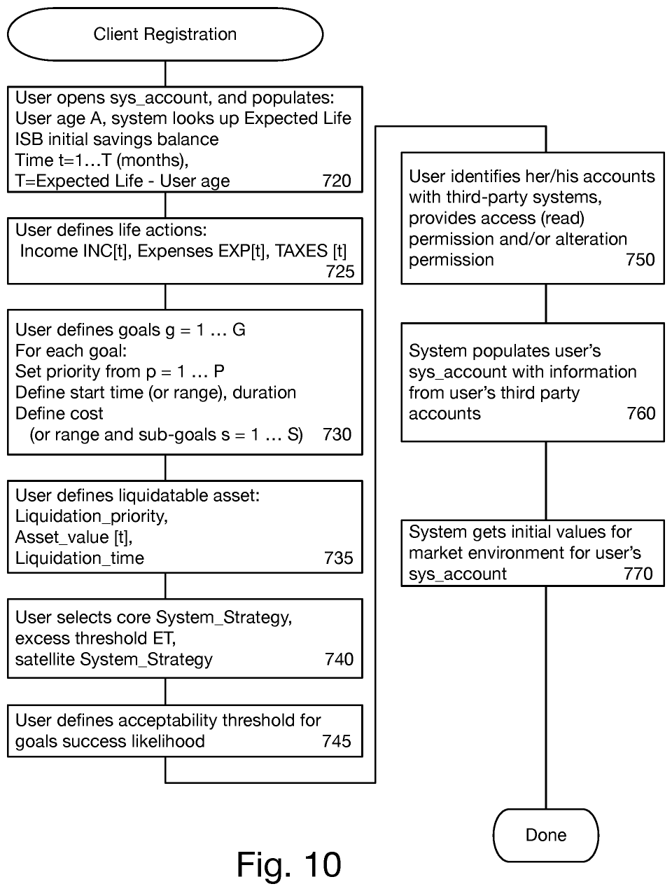

FIG. 10 is a flowchart showing client registration in a financial planning system according to the present invention. The person performing the steps is referred to as the user, and can be the financial planner or the client herself. The information created during client registration is stored in a suitable storage, such as client storages 540, 555, 575, 595 shown in FIG. 5.

At step 720, the user creates an account for herself and populates it with user descriptive information, including the user's present age, initial savings balance ISB (which can be negative if the user has outstanding loans such as student loans and/or a home mortgage). In this embodiment, the financial planning system then looks up the user's expected life from a stored table, and enables the user to adjust her expected life. The financial plan will be for a duration of T months, with T=12*(Expected Life (years)−Current Age (years)).

At step 725, the user specifies her life actions resulting in income, expenses or taxes for the duration of the financial plan, using the life action templates defined at step 715. Life actions are things that the user has already committed to, such as repaying the user's student loans.

At step 730, the user defines her goals using the goal templates defined at step 715. Goals are things that the user would like to commit to if affordable.

At step 735, the user defines her liquidatable assets, using the life action templates defined at step 715. For instance, the user may already own a home, and be willing to liquidate this upon retirement. In some embodiments, steps 725 and 735 are combined.

At step 740, the user selects her core System_Strategy from the strategies defined at step 710, defines her excess threshold ET, and selects her satellite System_Strategy from the strategies defined at step 710. The system uses the core System_Strategy until the user's excess wealth exceeds the excess threshold, at which point the system switches to the satellite System_Strategy. The default is to use the core System_Strategy for wealth up to the excess threshold, and then use the satellite System_Strategy for wealth exceeding the excess threshold; however, in some embodiments, the user may specify that the satellite System_Strategy is used for all wealth.

In some embodiments, the user specifies a first core System_Strategy, and then after ET is reached, specifies a second core System_Strategy in lieu of the first for wealth up to ET, and then a third System_Strategy for wealth exceeding ET. For example, the user may select a first medium risk strategy as her core System_Strategy, such as an equity index investment, and then after excess wealth exceeds ET, switch to a low risk strategy as her core System_Strategy for her wealth up to ET, such as a government bond fund, and a high risk strategy for excess wealth exceeding ET, such as a foreign country small cap equities investment.

In some embodiments, the user can specify multiple excess thresholds ET_1, ET_2, ET_3, . . . with respective System_Strategies.

In some embodiments, the financial planning system suggests System_Strategies based on the value of the excess threshold. For instance, for an excess wealth threshold of $3 million, the system might suggest a bitcoin investment, or for an excess wealth threshold of $10 million, the system might suggest original artwork or other investment having a relatively unpredictable return.

At step 745, the user defines her scenario acceptability threshold. This pre-defined acceptability enables the financial planning system to automatically decide whether a financial plan is acceptable, whereas conventional financial planning systems leave that decision to the user, expecting the user to iterate for awhile. For example, the user may define acceptability as Acceptability=[p1 80%, p2 60%, p3 40%] meaning a financial plan is acceptable if it has at least an 80% chance of achieving priority 1 goals and at least a 60% chance of achieving priority 2 goals and at least a 40% chance of achieving priority 3 goals.

If the user is concerned with having all of her goals met, then goals success likelihood is defined as at step 280 of FIG. 3D and acceptability is the minimum chance of achieving all of her goals that the user is comfortable with, such as 0.85, that is, an 85% chance that she will achieve all of her goals. Alternatively, the user can specify that goals of up to a particular priority level pAccept must be met for acceptability, so that goal success likelihood considers only those priority levels, while goals at less important priority levels are ignored for acceptability:

Goal_success_likelihood=N⁻¹*Σₙ₌₁^{N}1(B[n,T]>Benchmark_{pAccept}) (equation 15)

In other embodiments, other techniques for defining acceptability are used.

At step 750, the user identifies the client's accounts with third-party systems, such as banks or brokerages, and provides access (read) and/or alteration permission.

At step 760, the financial planning system populates the client's account with information from the client's third-party accounts.

At step 770, the financial planning system gets initial values for the market environment for the client's account.

FIGS. 11A-11C are a flowchart showing operation in a financial planning system according to the present invention. One embodiment is shown; other embodiments are contemplated. The information created during operation is stored in a suitable storage, such as client storages 540, 555, 575, 595, shown in FIG. 5.

Step 810 is similar to step 255 of FIG. 3D. Typically, about N=1,000 Monte Carlo simulations are performed, but any number may be used as long as it is large enough so that the statistical distribution across scenarios is realistic, such as N being at least around 100. The market rates for future times are projected using the Monte Carlo simulations created at this step. The market rates m=1 . . . M correspond to respective rates typically used in finance, such as the Fed Funds rate, inflation, the US 5 year borrowing rate, the US 10 year borrowing rate, the Prime rate, or the 11th District Cost of Fund Index (COFI).

At step 820, for each priority level, the benchmark curves are determined. In one embodiment, MWAG curves based on hypothetical wealth, discussed with respect to FIGS. 8A-8H, are used as the benchmark curves.

FIG. 11B is a flowchart showing generation of MWAG curves as the benchmark curves.

At step 910, the investment weights w(k) are selected. The investment weights do not vary with time, and the rate of return of each investment also does not vary with time. Typically, the core System_Strategy from step 740 is used as the Selected Strategy for determining w(k), with the fixed return for each investment being the most conservative expected return.

At step 920, the current priority level is set to “1”.

At step 930, Cumulative_Savings is initialized to the ISB from step 720.

At step 940, all of the goals at the current priority level are converted to life actions. If the goal has a time range, the latest start date is used. If the goal has a value range, it is split into sub-goals, so that a MWAG curve will be generated for each sub-goal.

At step 950, the user's wealth (Cumulative_Savings) is calculated for each period of the financial plan, thereby generating a Wealth curve for the current priority level.

At step 960, the financial planning system determines the MWAG curve corresponding to the Wealth curve for the current priority level.

At step 970, the current priority level is incremented by one.

At step 980, the financial planning system checks whether the current priority level exceeds the maximum priority level P defined at step 730. If not, processing returns to step 930. If so, processing is complete, that is, the benchmark curves have been determined.

Returning to FIG. 11A, at step 830, the System_Strategy y(i), typically the core System_Strategy selected at step 740, specifies the initial investment weights. The strategy enables the user to change her investment allocation over the duration of the financial plan. In contrast, a conventional financial plan uses the same investment allocation for the duration of the financial plan, as shown at step 260 of FIG. 3D.

At step 840, the financial planning system sets the initial account balance B[t=0] to be the ISB defined at step 720.

At step 850, the financial planning system creates the N scenarios based on the selected system investment strategy, the benchmark curves, the user's goals and life actions, and the Scenario Investment Return SIR[n,t,v] from the Monte Carlo simulations.

For each scenario n, for each time period t, for each priority level p, and for each subgoal s (if any goal has value variability represented as sub-goals):
The financial planning system first determines whether the user's current savings balance B[n,t−1] is less than the benchmark curve for this priority level, that is, whether the user cannot afford all goals at this priority. If so, the system determines whether asset liquidation is available at this priority level, at this time, and would result in the user's current savings balance exceeding the benchmark curve; any such assets are “suitable assets” and are automatically liquidated by the system. The fact of asset liquidation, and the date it occurs, form part of the financial plan. Conventional financial planning systems are unable to automatically decide when and whether to liquidate assets.
Next, the financial planning system determines whether the user's current savings balance B[n,t−1], with any adjustments from asset liquidation, is at least equal to the benchmark curve for this priority level, that is, whether the user can afford any goals at this priority. If so, the system converts such goals to life actions, sometimes referred to as “commits” such goal. The fact of goal commitment, the date it occurs, and the value of the goal (if the goal was specified with a value range) form part of the financial plan. Conventional financial planning systems are unable to automatically decide when and whether to commit to goals, as such systems assume all goals are required. The present financial planning system is far more efficient from a user's viewpoint than conventional financial planning systems because it obeys the user's goal preferences, expressed as goal priorities, in automatically deciding which goals are achievable based on the user's situation.
Next, the investment weights w[n,t,k] for this period are automatically determined based on the current savings balance B[n,t-1], the benchmark curve, and the weights for the selected strategy y(i) at this time. The core System_Strategy provides the investment weights until the user's “excess wealth”, defined as (B[n,t-1]−Benchmark) exceeds the excess threshold ET defined at step 740, at which point the satellite System_Strategy provides the investment weights. For instance, when minimum wealth to achieve goals is used as the benchmark, then the value of the curve for the least important priority goal is subtracted from the current wealth to yield the excess wealth. When the excess wealth exceeds the excess threshold ET, the System_Strategy changes to the satellite System_Strategy.
Then the financial planning system system computes the Net Savings NS[t] for all life actions:

NS[t]=INC[t]−EXP[t]−TAXES[t] (equation 16)

where

INC[t]=Σₖ₌₁^{K}LA_INC[k,t,n] (equation 17)

EXP[t]=Σₖ₌₁^{K}LA_EXP[k,t,n] (equation 18)

TAXES[t]=Σₖ₌₁^{K}LA_TAX[k,t,n] (equation 19)
Then the financial planning system computes the scenario's Portfolio Return PR[n,t], similar to step 275 of FIG. 3D:

PR[n,t]=Σₖ₌₁^{K}SIR[n,t,k]*wI[k] (equation 20)

and computes the account balance B[n,t] similar to step 275 of FIG. 3D:

B[n,t]=(1+PR[n,t])*B[n,t−1]+NS[t] (equation 21)
The financial planning system rebalances the goal account investments to conform to the weighted allocation in the selected System_Strategy. It will be recalled that since different investments may experience different growth, the portfolio needs to be rebalanced.
The financial planning system determines whether rebalancing would result in any trades that incurred capital gains or losses, and if so, adjusts the user's tax liability for the next period t+1 accordingly. Conventional financial planning system do not do this.
At the conclusion of the scenario, the financial planning system stores the account balance B[n,t=T], also referred to as the wealth or the cumulative savings.

At step 860, the financial planning system determines the goals success likelihood across all scenarios. As used herein and in the claims, for a goal to be successful, the financial planning system must commit that goal, and successfully fund that goal. Successful funding generally corresponds to the user's wealth remaining above the MWAG curve for the duration of the goal.

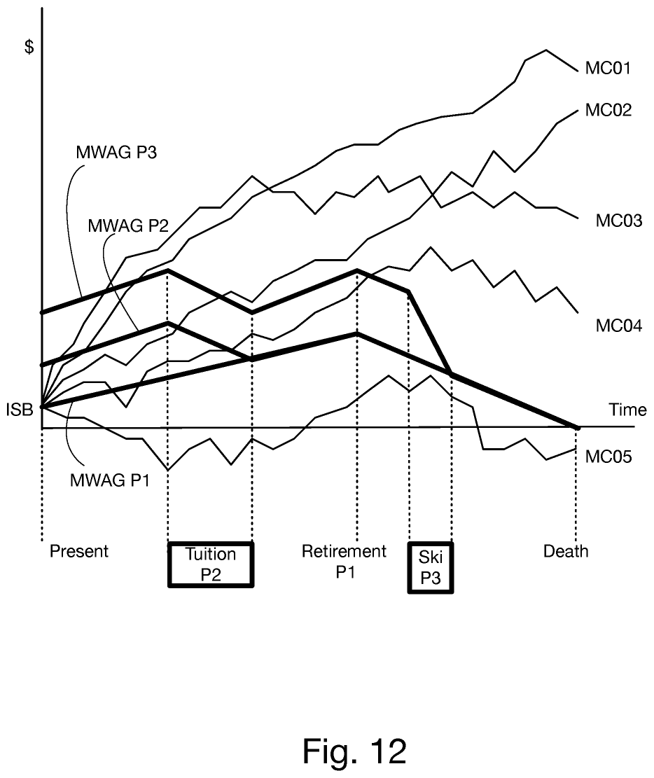

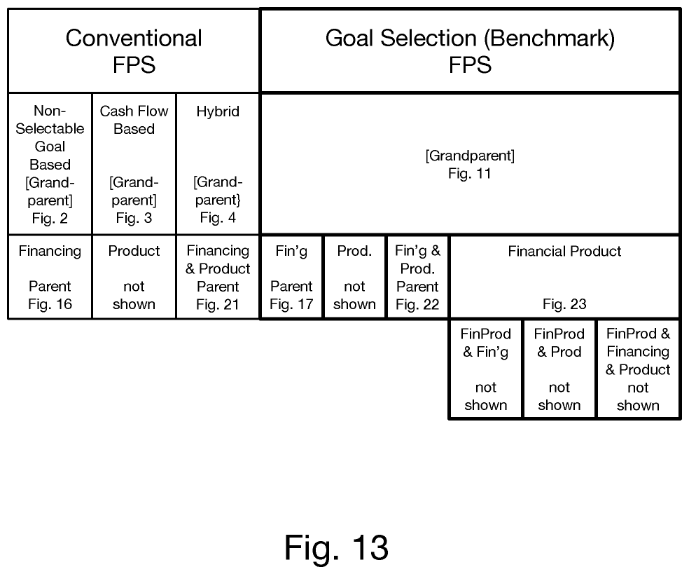

An example of determining goals success likelihood will now be discussed with reference to FIG. 12, showing five wealth simulation scenarios MC01 . . . MC05, with Monte Carlo simulations used to determine investment performance, along with the MWAG curves of FIG. 8H.

The sole priority 1 goal in this example is retirement, corresponding to the MWAG P1 curve. At the start of the retirement goal, indicated as a vertical dashed line, four of the five simulation scenarios are above the MWAG P1 curve, so the probability that the retirement goal will be achieved is ⅘=80%.

The sole priority 2 goal in this example is tuition, corresponding to the MWAG P2 curve. At the start of the tuition goal, indicated as a vertical dashed line, two of the five simulation scenarios are above the MWAG P2 curve, so the probability that the tuition goal will be achieved is ⅖=40%.

The sole priority 3 goal in this example is a ski trip, corresponding to the MWAG P3 curve. At the start of the ski trip goal, indicated as a vertical dashed line, four of the five simulation scenarios are above the MWAG P3 curve, so the probability that the ski trip goal will be achieved is ⅘=80%.

Generally, it is desirable that priority 2 goals have a higher success likelihood than priority 3 goals. However, in the scenario of FIG. 12, the priority 3 goal was more successful due to timing: it occurred much later in the user's life than the priority 2 goal, by which time the user was able to save enough for the priority 3 goal.

At step 870, the financial planning system decides whether the Financial Plan is acceptable in accordance with step 745. If so, processing continues at step 890. For example, if the user's acceptability threshold is Acceptability=[p1 80%, p2 60%, p3 40%], then the example of FIG. 12, wherein goals success=[p1 80%, p2 40%, p3 80%] is unacceptable because the p2 goal likelihood is 40% but the p2 acceptability threshold is 60%.

If the Financial Plan is not acceptable, at step 880, the user revises goals and/or priorities and/or investment allocation strategies and/or acceptability threshold and processing returns to step 820. At step 880, the financial planning system may suggest strategies or investments to the user, with the suggestions based on the user's wealth and goals. Exemplary suggestions made by the financial planning system may be:
asset liquidation beyond what the user has deemed acceptable liquidation priority when defining the asset;
obtaining a loan to fund the user's goals; and/or
choose a riskier core System_Strategy in the hope of higher returns; and/or
adjust acceptability threshold.
   As a further example, in one embodiment, a unique “inherent priority level” field is added to each goal template defined by the financial planner, see Table 1 field 2A; and at step 880, the financial planning system suggests altering the priority of the goal in accordance with its inherent priority level.

At step 890, the financial planning system defines the user's Financial Strategy as the parameters leading to goals success likelihood deemed acceptable at step 870. These parameters include the initial savings balance specified at step 720, the life actions specified at step 725, the goals and priority levels specified at step 730, the liquidatable assets specified at step 735, the System_Strategies specified at step 740, the acceptability threshold specified at step 745, and the benchmark curves determined at step 820.

Conventional financial planning systems produce a financial plan, possibly misleading the user into false certainty regarding goal achievement. In contrast, the present financial planning system produces a financial strategy with success likelihoods for the goals, more accurately representing future uncertainty to the user.

At step 895, the financial planning system implements or applies the Financial Strategy deemed acceptable at step 870, as shown in FIG. 11C.

Turning to FIG. 11C, at step 1010, the financial planning system synchronizes the present time with the time t=1 of the Financial Strategy deemed acceptable at step 870.

At step 1020, if the customer, also referred to as the user or the client, has given permission, the financial planning system automatically moves funds among accounts, and/or places trades in accordance with the Financial Strategy. Fund movement occurs when the ISB is allocated among accounts, when the monthly savings is allocated among accounts, and when accounts are rebalanced to conform to the financial plan.

At step 1030, for those actions specified by the Financial Strategy that cannot be automatically accomplished, the financial planning system notifies the customer of what actions to take. For instance, if an asset such as a painting is to be liquidated, the customer is notified.

At step 1040, the user optionally updates information or adds new information. Examples of updating information are: changing the parameters of life actions or goals, or deleting life actions or goals. Examples of adding new information are: adding new life actions, adding new goals or financial accounts.

At step 1050, the financial planning system determines that sufficient time has elapsed so that the next period t+1 of the Financial Strategy has arrived. Typically, at step 720, the financial period is defined as a month, but in some cases it may be a week, a bi-week, a quarter-year, a year or other suitable timeframe.

At step 1060, the financial planning system checks whether the user is still alive, or whether another condition at the end of the Financial Strategy has occurred. If so, processing is complete. If not, processing continues to step 1070.

At step 1070, similar to step 770, the financial planning system gets current values for the market environment for the client's account.

At step 1080, the financial planning system determines whether a new financial strategy is needed. Generally, a new financial strategy is needed when at least one of the following events has occurred, as specified by the user, indicating a change to wealth over time:
changes in life actions,
changes in goals,
changes in System_Strategy,
changes in acceptability threshold,
new user account information, particularly a new type of account such as a 401(k) account.
   If none of the above events has occurred, that is, no events or only events indicating a change to the status of the wealth, such as updating the current wealth or the liquidation value of a life action, then a new financial strategy is not needed, and processing continues at step 1090. If a new financial strategy is needed, processing returns to step 820 in FIG. 11A, except with the initial savings balance reset to the current wealth, that is, ISB=B[t].

At step 1090, only the period t+1 of the existing Financial Strategy is computed, reflecting the current market environment from step 1070 and any changes to current position made by the user at step 1040. Processing at step 1090 is similar to processing at step 850, but for only n=reality (instead of one of N simulation scenarios) and only t=t+1 (instead of t=1 to T), and will not be discussed in detail for brevity. Step 1090 comprises implementing the acceptable financial strategy by determining actions period-by-period. Then, processing continues at step 1020.

An advantage of the present financial planning system is that if there have been no material changes in the user's circumstances since the last period, only the current period needs to be computed at step 1090; in contrast, a conventional financial planning system gives only a plan for one period, and needs to be completely re-run at a next period. The present financial planning system needs to be completely re-run only in a period where there have been material changes in the user's circumstances (the “yes” branch from step 1080 to step 820, indicated by AA in a circle).

### Relationship of Subject Matter of Related Applications

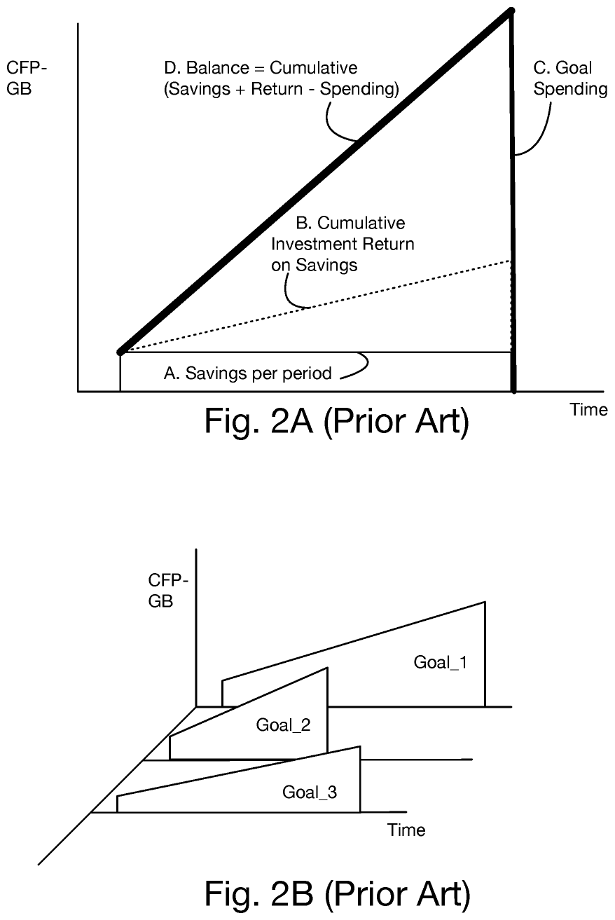

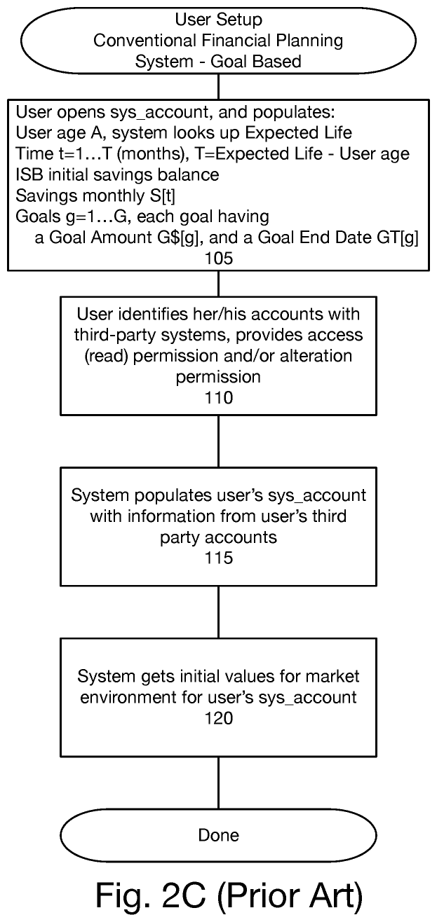

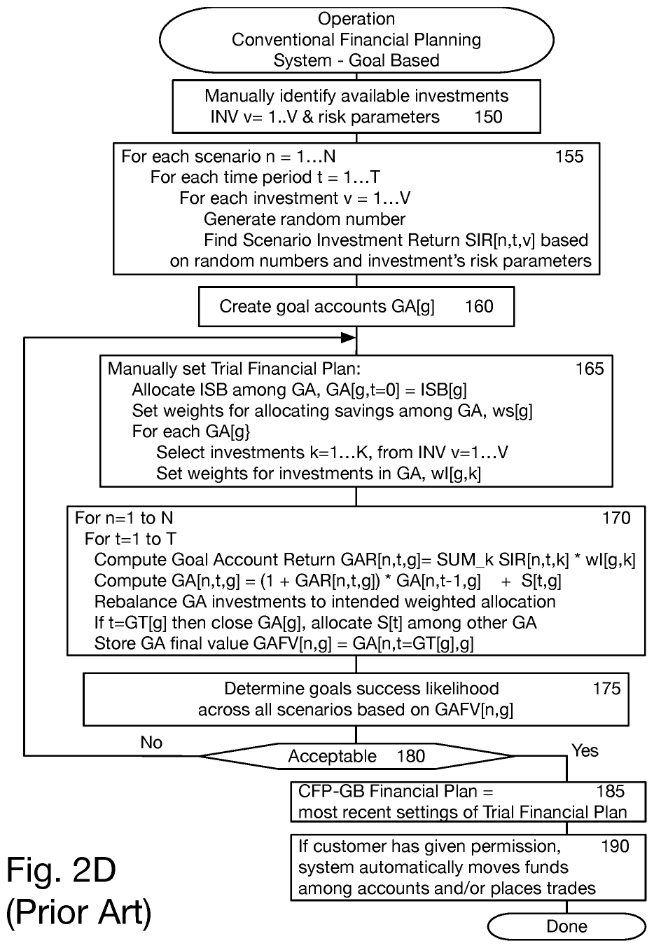

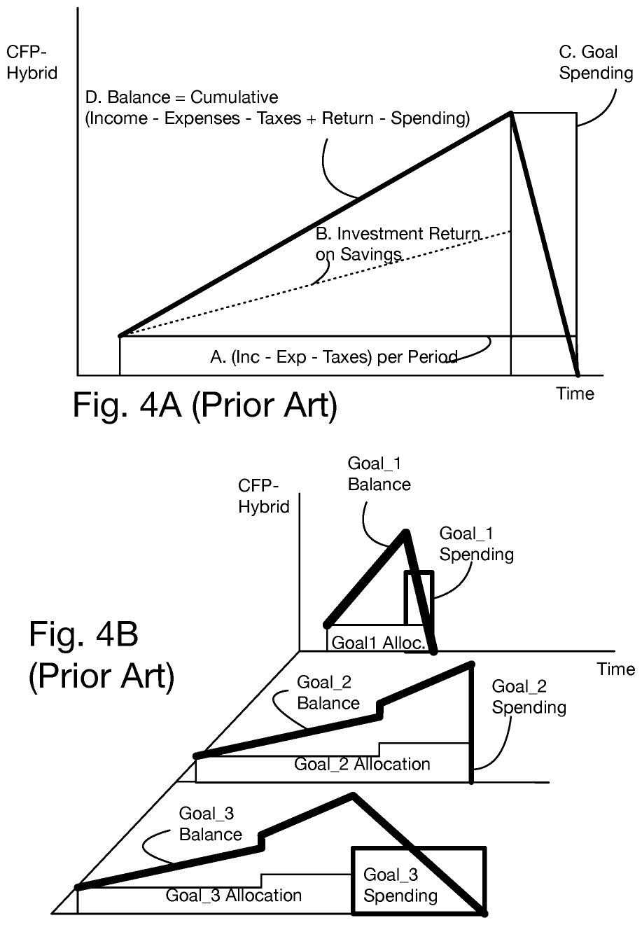

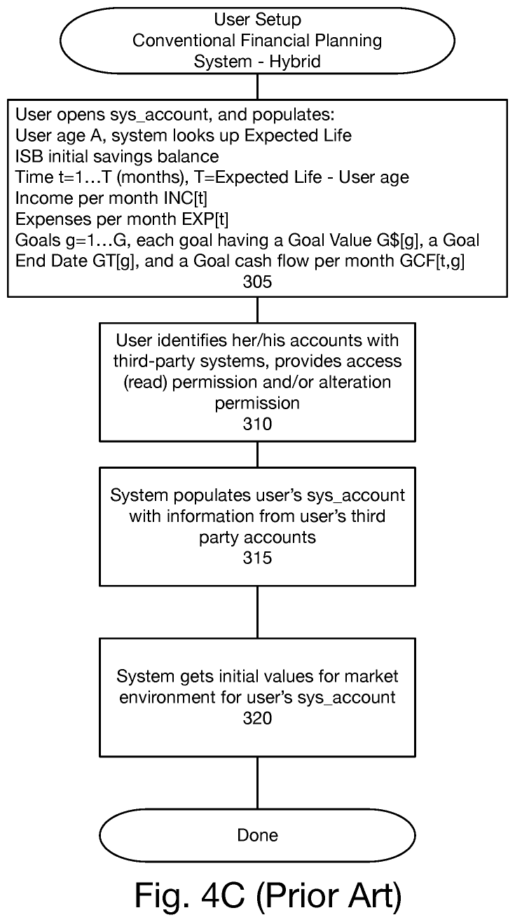

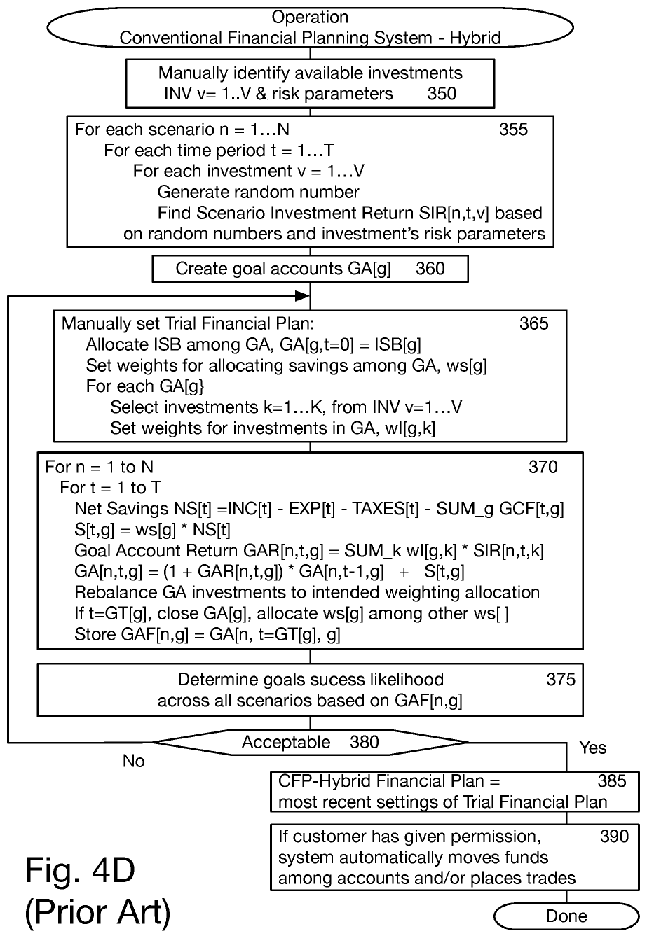

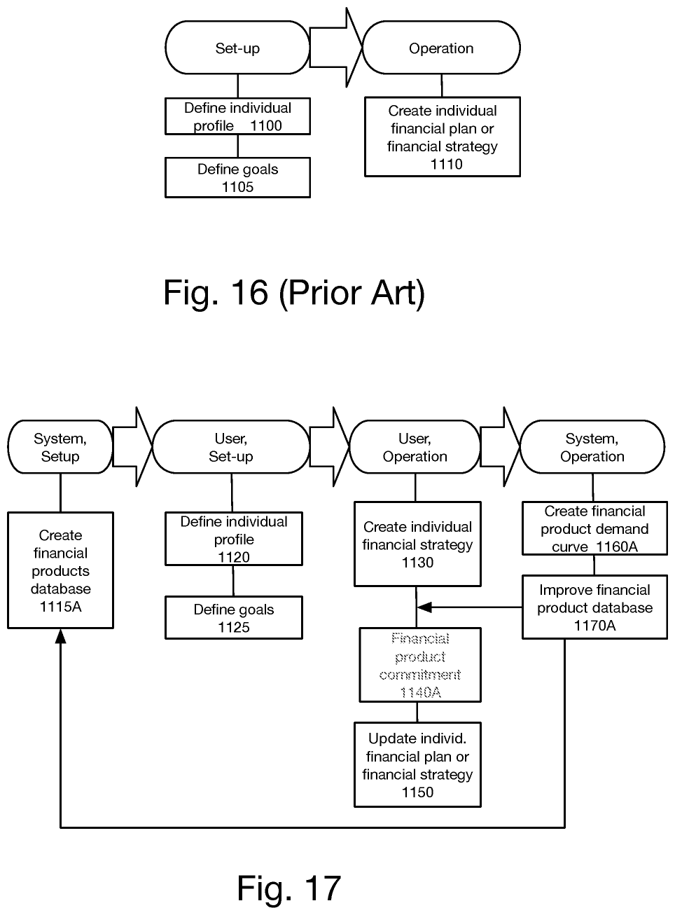

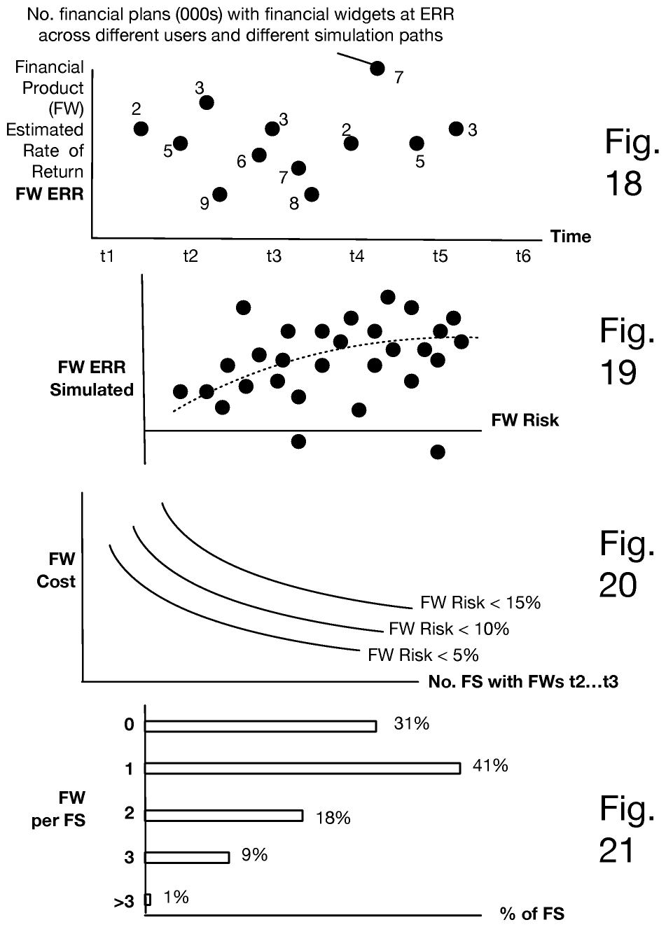

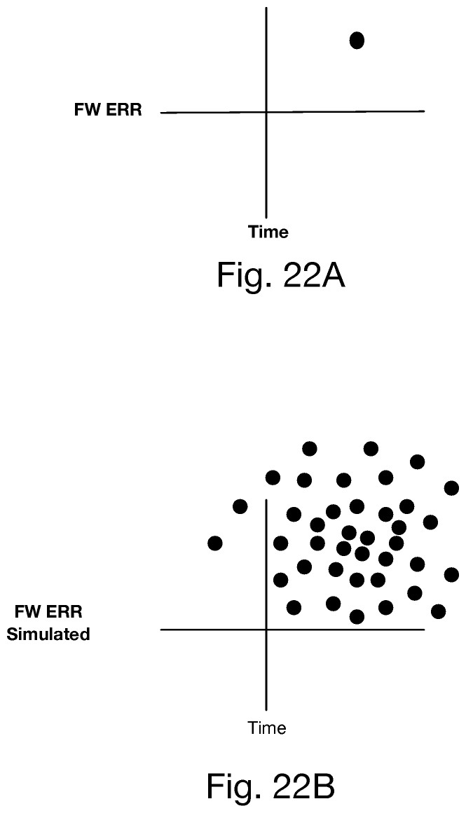

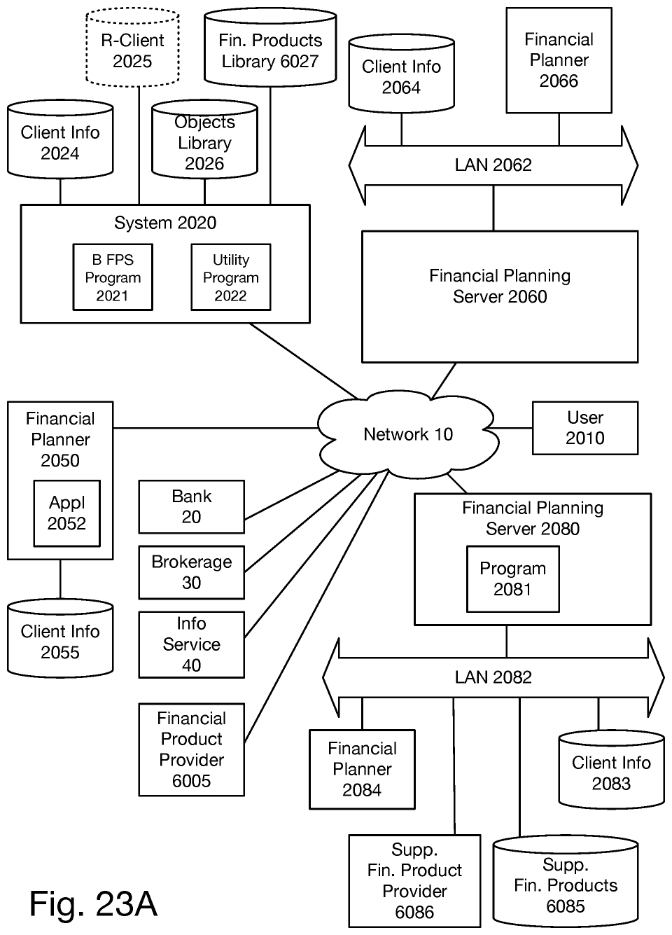

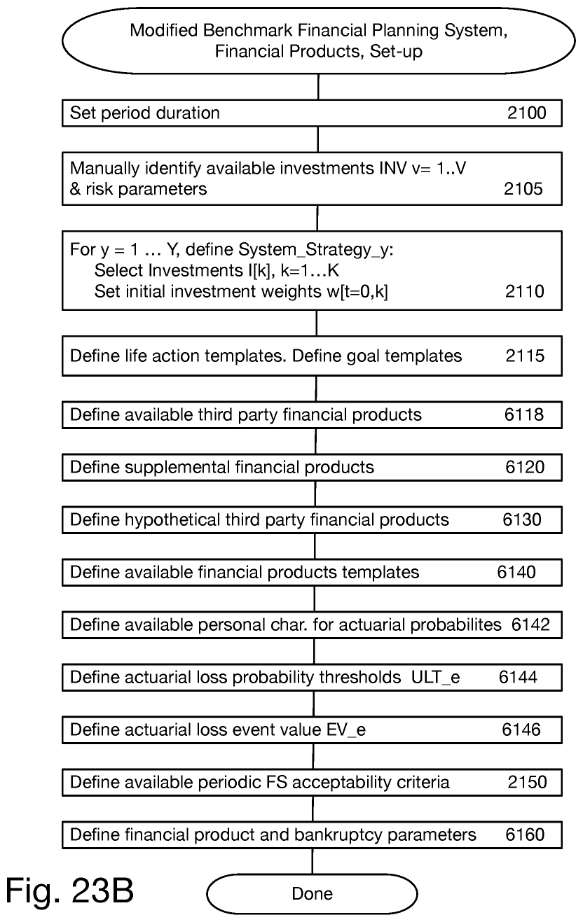

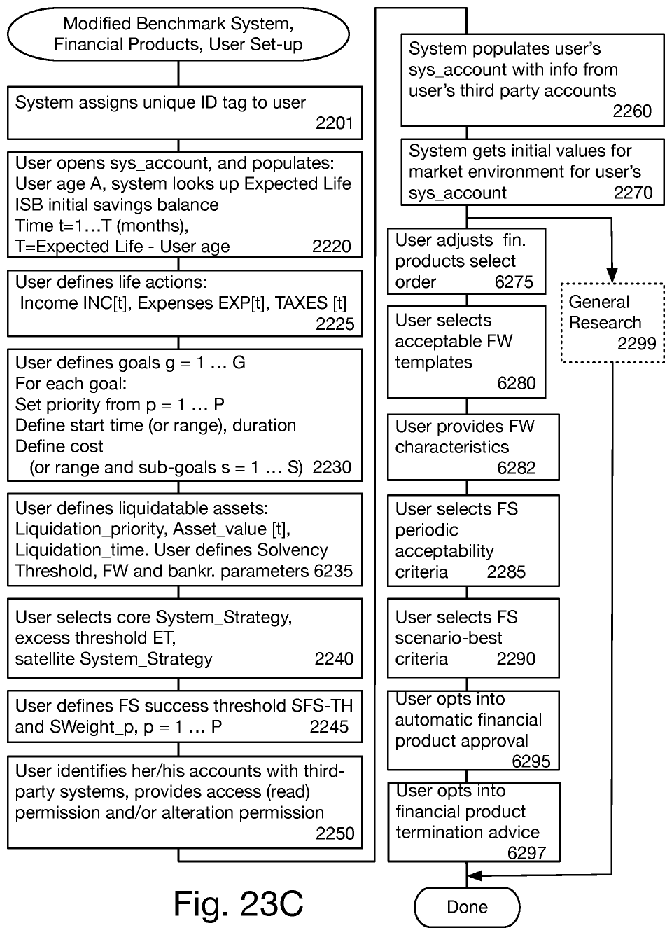

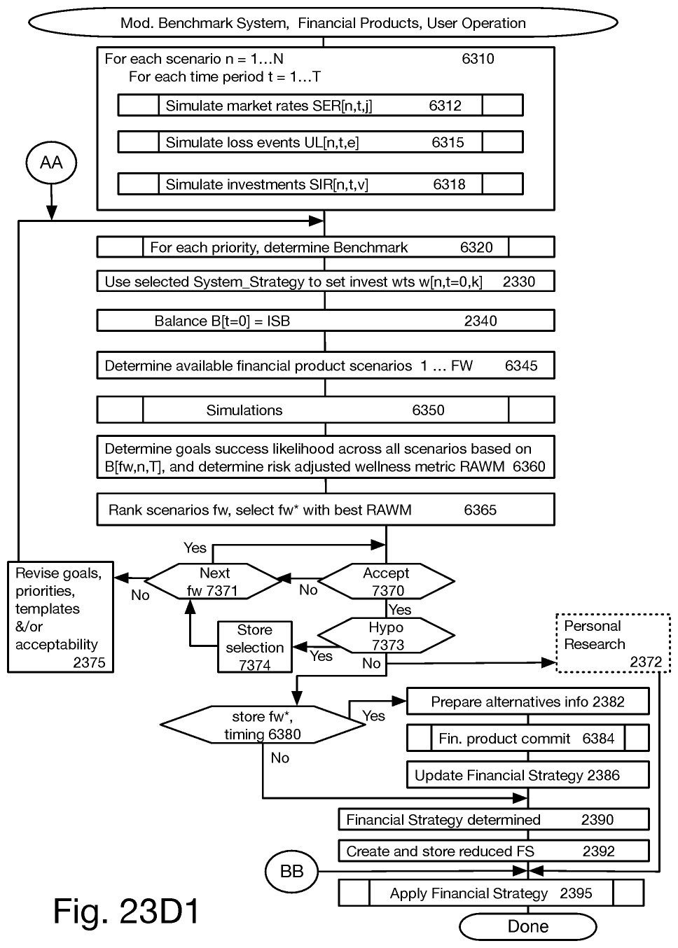

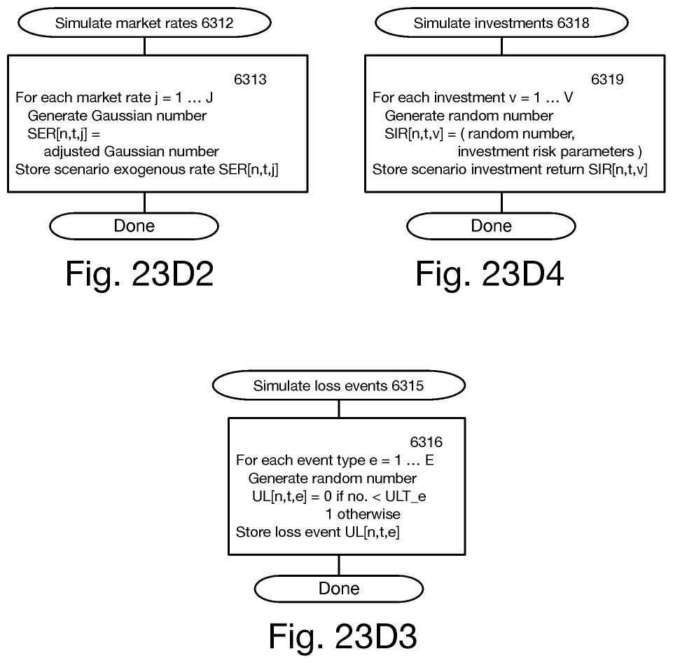

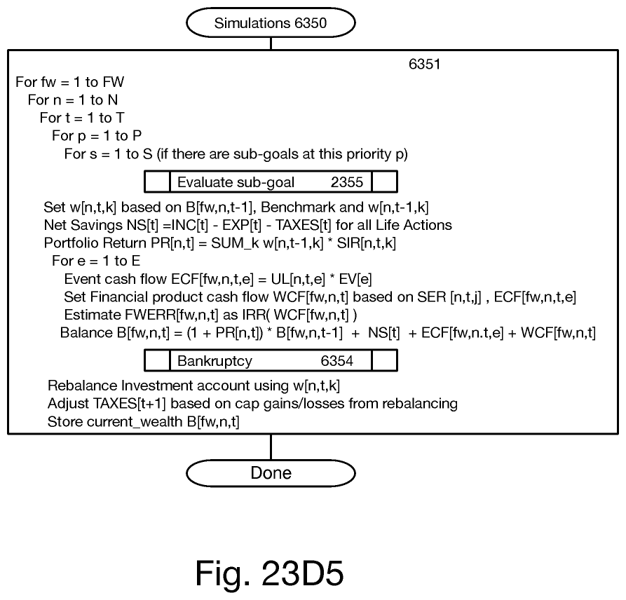

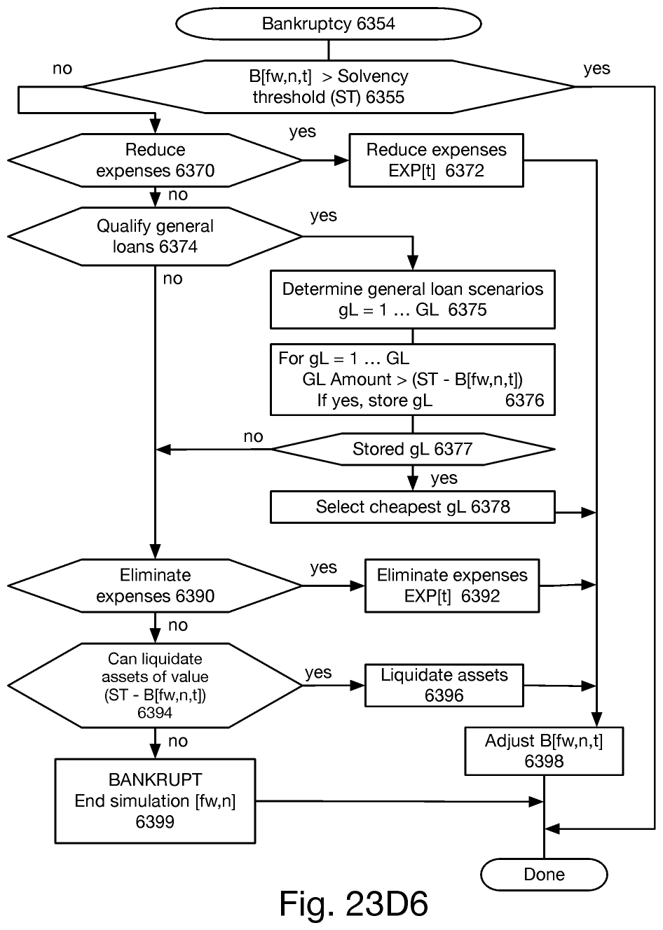

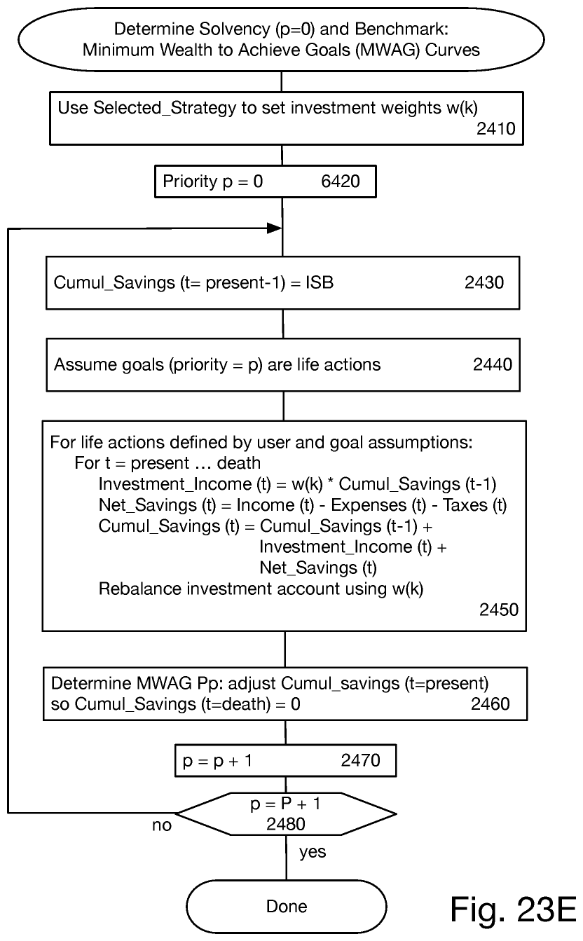

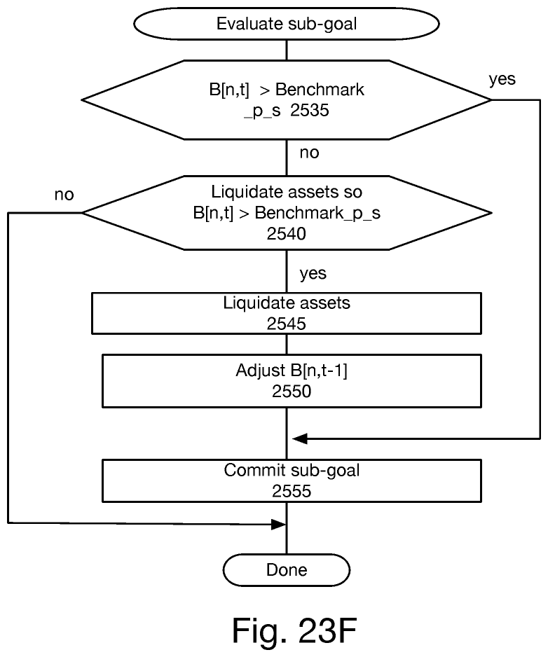

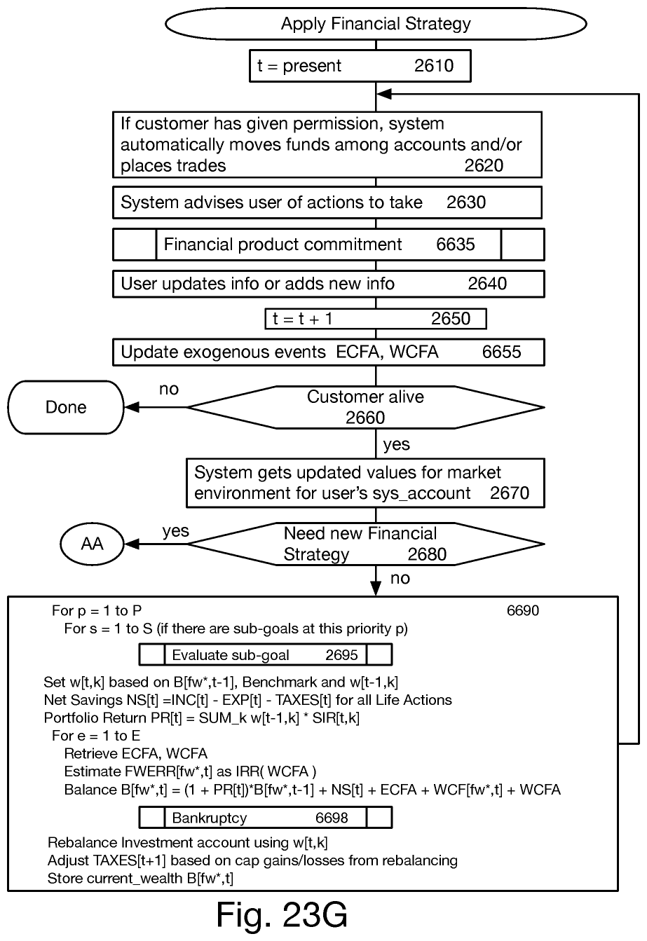

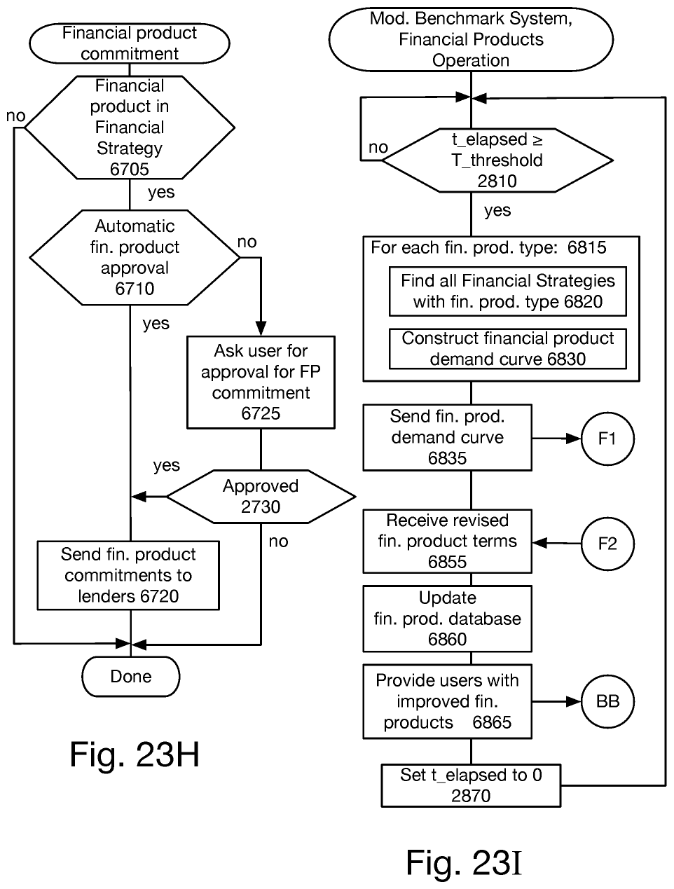

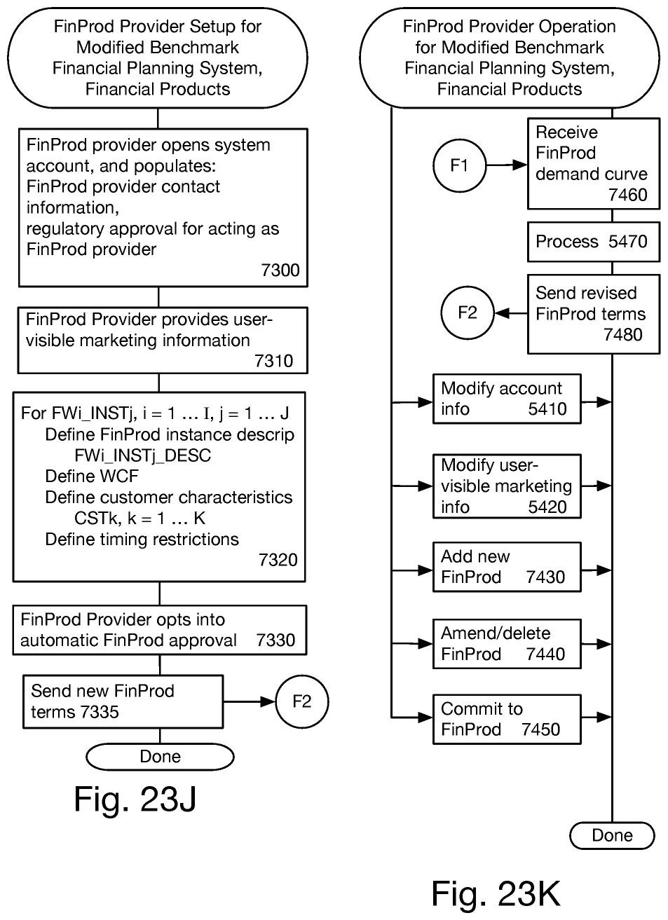

FIG. 13 is a chart showing the relationship of the subject matter of this application, and its parent application Ser. No. 16/731,021 and grandparent application Ser. No. 15/960,637. As used in the chart of FIG. 13 and discussion thereof, “FIG. 2”, “FIG. 3”, “FIG. 4” and “FIG. 11” respectively collectively reference FIGS. 2A-2D, FIGS. 3A-3D, FIGS. 4A-4D and FIGS. 5 to 11A-11C, and these are the same figures in the instant application, the parent of the instant application, and the grandparent of the instant application; “FIG. 16”, “FIG. 17”, “FIG. 21” and “FIG. 22” respectively collectively reference FIGS. 16A-161; FIGS. 17A-17K, FIGS. 21A-21M and FIGS. 22A-220 of the parent application; and “FIG. 23”, collectively references FIGS. 23A-23K of the instant application.

Three forms of a conventional FPS are respectively shown in FIGS. 2, 3 and 4. A benchmark FPS, also referred to as a goal selection FPS because it automatically decides which of a user's goals to include in a financial strategy by comparing simulation results with a benchmark, is shown in FIG. 11.

The parent application hereto discloses augmenting these FPS with the ability to choose financing and/or products. FIG. 16 shows a conventional FPS augmented to choose financing; FIG. 21 shows a conventional FPS augmented to choose financing and goal products; FIG. 17 shows a goal selection FPS augmented to choose financing, and FIG. 22 shows a goal selection FPS augmented to choose financing and goal products.

FIG. 23 shows a goal selection FPS augmented to choose financial products. The goal selection FPS of FIG. 23 can be further augmented to choose goal-related financing, goal products, and the combination of goal-related financing and goal products.

The point of the chart of FIG. 13 is that financial products, goal-related financing and goal products are different things. A financial strategy can include none, one, two or all three of these. For example, a FPS can produce a FS wherein the following have been automatically selected for the user: life insurance, property insurance, a hedge fund investment, a mortgage for a vacation condominium, a washer/dryer with manufacturer financing, and a car with manufacturer financing.

### FPS with Automated Selection of Financial Products

A financial product is sometimes referred to as a financial widget (FW), so that its acronym is distinguishable from the acronym for a financial plan. A FW is defined above.

A financial product by itself does not represent a goal, but rather should be considered as a tool that can help achieve desired goals. Examples of financial products are:
Speciality investment products open only to accredited investors, such as hedge funds, venture capital funds or private equity funds, as distinguished from investments open to all investors that are typically in the user's investment portfolio, such as stocks, bonds, mutual funds and exchange traded funds (ETFs);
Structured products, such as contracts that provide certain amount of downside investment protection in exchange for either additional fees or a portion of the upside performance of the underlying investment product such as the S&P 500 Index fund;
Insurance contracts that provide coverage for various types of event risk, including Life Insurance, Long Term Disability, Property and Casualty, Liability, Auto, Renters, etc;
Annuities and variable annuities, which provide future lifetime income in exchange for an early investment stream; and
General financing is a type of financial product. In the parent application, financing is tied to a goal (product or service). In this application, a financial product is not tied to a goal, rather, its purpose is timing of cash flows within the FS. General financing may be based on general collateral. General financing is useful for emergency events.
   Financial products have fees, that can be fixed or variable. The fees can be charged separately or embedded in periodic payments from the user.

For financial products directed towards risk mitigation or shifting, the present FPS optimizes the portion of a user's resources that should be paid based on risk-adjusted acceptability criteria that include (a) an acceptability threshold for achieving the user's goals, and (b) a penalty for when the probability of bankruptcy exceeds a threshold.

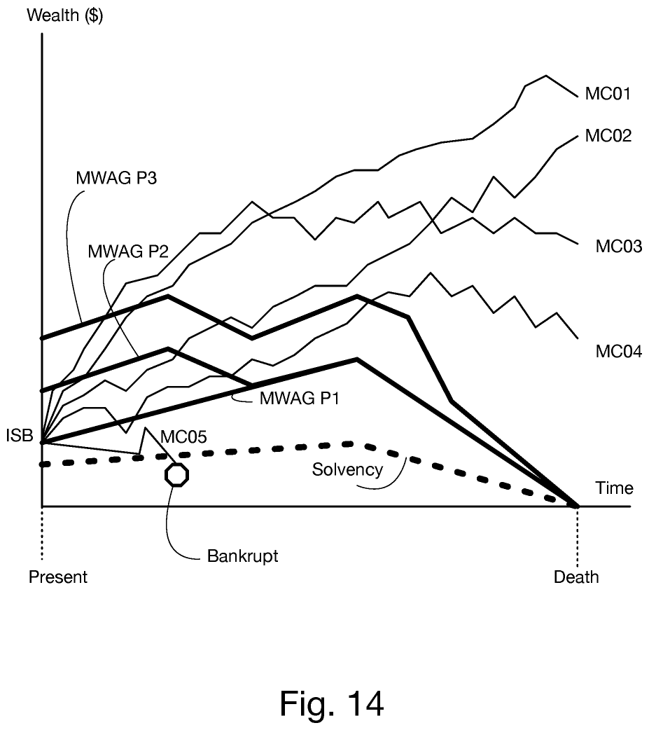

FIG. 14 is a graph showing Monte Carlo simulations of a user's financial life with a bankruptcy simulation. As explained in detail below, at each time interval t, the user's current wealth is compared to a solvency threshold. When the current wealth exceeds the solvency threshold, bankruptcy is not a concern. When the current wealth is less than the solvency threshold, the MBFPS automatically tries to take a prophylactic measure to prevent bankruptcy, the prophylactic measure being one or more of reducing expenses, eliminating expenses, getting one or more general loans, or liquidating assets to make up the difference between the solvency threshold and current wealth. If prophylactic measures are sufficient, all is well. If prophylactic measures are insufficient, the MBFPS determines that bankruptcy should occur, and this simulation path ends. When a simulation path ends in bankruptcy, the acceptability of the user's FS is reduced (penalized).

A solvency problem could occur because of:
an exogenous event—an impersonal-to-the-user event that a user has no control over, such as a market crash, a terrorist attack, or an economic collapse;
a personal event that the user has no control over, such as a fire that destroys their home, a job termination without prompt re-employment, or a car accident resulting in high medical expenses;
investment risk—the user depends on investment income to cover their expenses, and has so much of their assets in high risk investments that when a risk event occurs, the user cannot meet their expenses;
previous goal commitment that is unaffordable in view of current circumstances;
too high expenses—the user is living beyond their means.

Because of the program logic described above, a simulation path leading to bankruptcy, such as MC05 in FIG. 14, often shows decreasing current wealth when spending exceeds income, then an abrupt increase as assets (not included in the current wealth calculated for FIG. 14) are liquidated. Then, if the user's financial troubles continue, there are no more assets to liquidate, so the solvency threshold is passed and bankruptcy is declared.

The present FPS is believed to be the only one that models bankruptcy risk. As such, it provides a realistic dose of pessimism for the user's financial future; in other words, ignoring the risk of bankruptcy presents an overly optimistic future simulation.

The present FPS is able to reduce expenses by revising or canceling previously committed goals. In some embodiments, a goal can include a cancellation penalty so that it is less likely to be canceled, making a loan or asset liquidation appear more preferable.

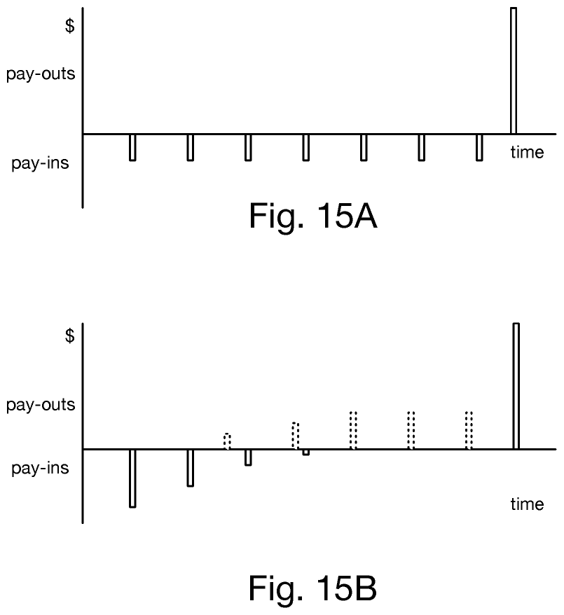

FIG. 15A is a chart showing the payment stream for a static financial product such as insurance. The user makes a series of payments, then upon occurrence of a specified event, the provider pays a lump sum to the user or the user's estate. Other static financial products are loans and mortgages, where the provider initially provides a lump sum to the user, and then the user makes a series of payments to repay the lump sum plus interest. Here, the payments are a fixed amount agreed upon at the start.

FIG. 15B is a chart showing the payment stream for a variable financial product such as insurance based on a market investment. The user agrees to make a series of payments that are invested in a market instrument, and if the market does well, the returns from the investment reduce or eliminate the periodic payments due from the user. Here, the market returns are shown as dotted lines because they are not actually paid out to the user, they just reduce the periodic payments. Then, upon occurrence of a specific event, the provider pays a lump sum to the user. This is a particularly popular form of life insurance for trusts. In a Crummey trust the trust buys a life insurance policy on the life of a parent, the parent pays the periodic payments as gifts to their beneficiary children, then upon the parent's death, the children receive the proceeds of life insurance tax-free.

Conventional FPS cannot properly represent the financial products of FIG. 15. As explained below, a goal selection FPS can properly represent the financial products of FIG. 15.

FIG. 16 is a chart showing the conventional process of financial planning. User set-up comprises steps 1100 and 1105. At step 1100, an individual's profile, comprising descriptive information and preferences specific to the user, is defined typically during registration. At step 1105, the user's goals for their financial plan are defined. During operation, at step 1110, the FPS creates the FP or FS, as discussed above with respect to a conventional FPS and a benchmark FPS.

FIG. 17 is a chart showing financial planning with automatically selected financial products.

At step 1115A, a financial products database is created comprising offers to provide financial products according to various terms, for users who meet the providers' criteria. Financial product providers specify whether they will automatically agree to sell financial products automatically selected by the FPS.

During user setup, a user's willingness to accept financial products is specified. In one embodiment, financial products are assumed to be acceptable, and the user can override this. In another embodiment, the user must “opt in” to financial products. The user also specifies whether s/he wishes to automatically commit to a financial product selected by the FPS. Otherwise, steps 1120 and 1125 of user set-up are similar to steps 1100 and 1105 of FIG. 16.

During user operation, at step 1130, generally similar to step 1110 of FIG. 16, the FPS creates the user's FP or FS, except now the FPS uses the financial products database to evaluate whether the user is eligible for financial products, and if so, to select the best financial product for the user. At step 1140A, if the user has agreed to automatically accept the automatically selected financial product, then the FPS purchases the financial product for the user from the financial product provider. At step 1150, the FPS updates the user's FP or FS.

In some embodiments, there is a “system operation” phase, typically at periodic intervals such as weekly or monthly, wherein at step 1160A, the FPS creates financial product demand curves (discussed below) based on the users' FPs or FSs and sends these curves to the financial product providers. Then at step 1170A, the FPS receives the financial product providers' responses, if any: either changes to existing financial product offers, or entirely new financial product offers. The FPS updates the financial products database with these updated or new offers. The FPS also notifies relevant users of these updated or new offers. Generally, a relevant user is one who has a similar financial product in their FP or FS, and for whom the updated or new financial product offers might result in a better outcome. At step 1140A, each user then determines whether or not to accept the updated or new financial product offer, which may involve prematurely terminating their previous financial product.

### Financial Product (FW) Estimated Rate of Return (FW ERR)

The financial product, or financial widget, (FW) estimated rate of return (ERR) FWERR[fw,n,t] is an expected internal rate of return (IRR) for the financial product, FWERR[fw,n,t]=IRR(WCF[fw,n,t]), where WCF[fw,n,t] is the financial product cash flow for the fw-th financial product scenario, the n-th simulation run, and time t of the simulation run, and is simulated in each of the simulations n, at each time point t, for each financial product fw, as explained below with respect to FIG. 23D5 step 6351. IRR is a commonly used financial metric: the discount rate that makes the net present value (NPV) of all cash flows equal to zero.

For these analyses, as distinct from “risk” in the risk adjusted wellness metric discussed below, “risk” is defined as the standard deviation of the financial product estimated rate of return, RISK=σ(FWERR). Standard deviation σ is a commonly used statistical function that measures the variation in a set of data:

$$RISK = \frac{1}{N} * SQRT ( {\sum }_{n = 1}^{N} {FWERR}_{n} - {FWERR}_{mean} ) \qquad ( equation 22 )$$

Financial product demand curves will now be discussed.

FIG. 18 is a graph showing the number of user financial plans with financial products of a particular type by time and by ERR, which is a precursor to a financial product demand curve. At step 1160A of FIG. 17, at periodic intervals, the FPS creates this graph by examining all stored FPs or FSs and seeing which have this type of financial product (FW), at which time. As explained below, during a set N of simulations for creating a FS, different FW may be selected in different of the simulations; the set of stored FS include only the FW chosen for the FS. As explained with respect to FIG. 22, each point in FIG. 18 is actually a probability density function.

FIG. 19 is a graph of FWERR plotted against risk. At step 1160A of FIG. 17, at periodic intervals, the FPS creates this graph by examining all stored FPs or FSs and reading the WCFs, stored at FIG. 23D1 step 6365, for the financial products in the stored FSs, then computing FWERR and RISK as explained above. Generally, as risk increases, simulated FWERR increases, as shown by the dotted line in FIG. 19.

Notice that simulated FWERR may be negative, corresponding to a financial product that is a lifetime bad purchase for this particular user.

FIG. 20 is a graph showing financial product risk demand curves for different costs, that is, for a particular type of financial product, the number of FPs or FSs at different risks. The FPS plots the financial products against their risks, as defined. A financial product provider who is good at managing risk might be willing to offer higher-rate products to higher risk borrowers, thus enabling a user to get a desired financial product despite being conventionally undesirable, for instance, a person seeking property insurance in a flood-prone areas. Similarly, a financial product provider might be willing to offer lower-rate financial products to lower risk borrowers.

FIG. 21 shows, for the stored user financial strategies (FS) accessible to the financial planning system (FPS), the usage of financial products (FW) in the stored financial strategies. Specifically, in this case, 31% of FS do not use FW, 41% of FS use one FW, 18% of FS use two FWs, 9% of FS use three FW, and 1% of FS use more than three FW. This chart is helpful for financial product providers to better understand their customers within the FPS user community.

Additional charts (not shown) are provided as appropriate, such as charts showing a particular type of financial product plotted against the user characteristic(s) most likely to determine whether a FS includes that type of financial product.

The present FPS is able to do something that no other FPS are believed able to do: evaluate the interaction of FWs in the user's FS. Conventionally, a user evaluates one FW at a time for inclusion in their financial plan. Perhaps an extremely sophisticated financial planner manually guesses at combinations of FWs that will be complementary. The present FPS lets the FWs interact with each other based on how they affect the user's simulated current wealth, at each time period, in view of simulated loss events, enabling the user to employ the combination of financial products that gives the user the best chance of achieving their goals.

Analysis (not shown) of the FS having two or more FWs leads to insights about complementary financial products, perhaps spurring creation of new types of FWs or bundling financial products as “special offers”. In other words, the present FPS is a tool for financial product providers to better understand their customers' needs.

FIG. 22A is a chart showing the deterministic nature of a conventional financial planning system, illustrating that the outcome is a FP where each financial product has constant FWERR, corresponding to the reality that a conventional FPS assumes a fixed behavior for a financial product.

FIG. 22B is a chart showing the probabilistic nature of a benchmark financial planning system, illustrating that the outcome is a FS where the FWERR of each financial product of the FS is best modelled as a density function over an area, as the Monte Carlo scenarios result in different FSs for different scenarios, as shown in FIGS. 12 and 14.

Thus, FIG. 18, for a benchmark financial planning system, should be understood as having density functions instead of point values as for a conventional financial planning system.

As is conventional in patent drawings, when only one instance of an item is shown for brevity, it will be understood that many instances of that item are possible and operate similarly.

### Modified Benchmark FPS with Automated Selection of Financial Products

The embodiment of FIG. 23 is a modified benchmark financial planning system (MBFPS) that supports a FS with automatically selected financial products. FIG. 23 is a detailed embodiment of FIG. 17.

A utility program receives and stores financial product offers from financial product providers, and makes these offers available to the MBFPS.

Each MBFPS stores user-selected financial product templates. The user adds their parameters to one of these templates to create a customized financial product template. Based on the financial product providers' offers and the user's customized financial product templates, the MBFPS selects financial products that comply with the user's financial product templates. Then the MBFPS creates a set of financial product scenarios fw=1 to FW.

As a first example, assume the user has customized (filled in parameters) for only one financial product template, for life insurance. There may be 27 different life insurance products known to the MBFPS. The MBFPS uses the template to determine that three of these life insurance products meet the user's criteria as expressed in their customized template. Thus, the number of financial product scenarios to be evaluated is FW=3.

As a second example, assume that the user, an accredited investor, has customized three financial product templates: for life insurance, for an annuity, and for specialty hedge fund investments. The MBFPS searches its database of financial product offers, and determines that three life insurance products, one annuity product, and two hedge fund products meet the user's customized templates. The scenarios that should be evaluated are shown in Table 7, where “0” means not using the product and “1” means using the product, assuming at most one instance of each product type is used:

TABLE 7
Financial product scenarios to evaluate

| | Life | Life | | | | |
|---|---|---|---|---|---|---|
| | Ins 1 | Ins 2 | Life Ins 3 | Annuity 1 | Hedge 1 | Hedge 2 |
| Scenario 1 | 0 | 0 | 0 | 0 | 0 | 0 |
| Scenario 2 | 0 | 0 | 0 | 0 | 0 | 1 |
| Scenario 3 | 0 | 0 | 0 | 0 | 1 | 0 |
| Scenario 4 | 0 | 0 | 0 | 1 | 0 | 0 |
| Scenario 5 | 0 | 0 | 0 | 1 | 0 | 1 |
| Scenario 6 | 0 | 0 | 0 | 1 | 1 | 0 |
| Scenario 7 | 0 | 0 | 1 | 0 | 0 | 0 |
| Scenario 8 | 0 | 0 | 1 | 0 | 0 | 1 |
| Scenario 9 | 0 | 0 | 1 | 0 | 1 | 0 |
| Scenario 10 | 0 | 0 | 1 | 1 | 0 | 0 |
| Scenario 11 | 0 | 0 | 1 | 1 | 0 | 1 |
| Scenario 12 | 0 | 0 | 1 | 1 | 1 | 0 |
| Scenario 13 | 0 | 1 | 0 | 0 | 0 | 0 |
| Scenario 14 | 0 | 1 | 0 | 0 | 0 | 1 |
| Scenario 15 | 0 | 1 | 0 | 0 | 1 | 0 |
| Scenario 16 | 0 | 1 | 0 | 1 | 0 | 0 |
| Scenario 17 | 0 | 1 | 0 | 1 | 0 | 1 |
| Scenario 18 | 0 | 1 | 0 | 1 | 1 | 0 |
| Scenario 19 | 1 | 0 | 0 | 0 | 0 | 0 |
| Scenario 20 | 1 | 0 | 0 | 0 | 0 | 1 |
| Scenario 21 | 1 | 0 | 0 | 0 | 1 | 0 |
| Scenario 22 | 1 | 0 | 0 | 1 | 0 | 0 |
| Scenario 23 | 1 | 0 | 0 | 1 | 0 | 1 |
| Scenario 24 | 1 | 0 | 0 | 1 | 1 | 0 |

There are 24 scenarios of financial product use that meet the user's customized financial product templates, so FW=24 for this example.

The MBFPS generates a set of simulations, and evaluates each financial product scenario in the set of simulations, estimating the user's wealth for each financial product scenario. Simple brute force evaluation requires an excessive amount of computation—e.g., 24 scenarios times 1,000 simulations per scenario requires 24,000 simulations—a preprocessing procedure may be used to winnow the number of simulations.

One preprocessing procedure evaluates the scenarios against a smaller set of simulations chosen to include an even distribution of “good outcome” versus “bad outcome” simulation paths, rather than a Gaussian distribution centered on “normal outcome” paths, then selects a predetermined maximum number of scenarios, that gave the best results, for full simulation. In this example, the preprocessing uses a set of 100 simulations, corresponding to 24*100=2,400 simulations, then the best eight are chosen for full simulations, corresponding to 8*1,000=8,000; the combined total of simulations including preprocessing is then 2,400+8,000=10,400, a significant reduction over 24,000 simulations without preprocessing.

The MBFPS chooses the financial product scenario that meets the benchmark curve and maximizes the user's risk adjusted wellness metric RAWM, explained below, for the user's financial strategy FS.

It will be appreciated that if maximizing wealth was the metric, it would lead to choosing the highest FWERR per unit of cost without regard to its risk, perhaps being irresponsibly dangerous as the risk of loss could increase to an excessive value. FIG. 19 shows that higher FWERR is proportional to higher risk. Using RAWM ensures that risk is not excessive.

If the user permits automated commitment, the MBFPS commits to the financial products in the FS.

The MBFPS sends an anonymized and compacted (“reduced”) version of the FS to the utility program. Periodically, the utility program reviews the reduced FSs, creates financial product demand curves for different financial product types, and sends the financial product demand curves to the financial product providers, to encourage them to provide financial product offers suited to the FS users. FIG. 23A shows the system of FIG. 5 modified to choose the best financial product for a FS. For brevity, only differences between FIG. 23A and FIG. 5 are discussed. User 2001 is an individual who uses FPS 2020 directly, such as via a smartphone or computer.

Financial product provider 6005 is a party registered with MBFPS 2020 to offer financial products to users of MBFPS 2020. Provider 6005 fills out a template to describe the nature of the financial product on offer, along with any characteristics of desirable customers and undesirable customers. For desirable customers, provider 6005 may configure MBFPS 2020 to automatically offer a discount. For undesirable customers, provider 6005 may configure MBFPS 2020 to automatically charge a premium, or to block such customers.

Provider 6005 specifies whether it agrees to automatically agree to provide financial products selected by MBFPS 2020. In some embodiments, automatic agreement is not merely a yes/no decision, but specifies the nature of the automatic agreement such as:
(a) “anonymous commitment”—agree to any purchaser who lacks undesirable characteristics,
(b) similar to (a) but requires independent confirmation of the purchaser's information and possibly automated additional information gathering such as a purchaser's credit score,
(c) agreement only after manual review or additional information gathering, or
(d) similar to (a) but require manual review for purchasers having undesirable characteristics.

Financial products library 6027 contains the financial product offers (completed templates) from financial product providers 6005, and financial product demand curves created by MBFPS 2020.

Reduced client database 2025 stores reduced (anonymized) forms of FS selected for users of MBFPS 2020, that are used in creating financial product demand curves.

Supplemental financial product provider 6086 represents the owner of server 2080, business partners of the owner of server 2080, and third parties offering financial product to customers of the owner of server 2080. For instance, supplemental financial product provider 6086 may be a large entity, such as a large investment bank, that offers financial products only to its employees and customers and other pre-approved individuals. Otherwise, supplemental financial product provider 6086 functions similarly to financial product provider 6005.

Supplemental financial products database 6085 stores the supplemental financial products offered by supplemental financial product provider 6086.

MBFPS 2020 includes the functions of system 500 of FIG. 5, and executes utility program 2022 that stores the descriptions of financial products from financial product providers 6005 in its financial products database 6027. Via an application programming interface (API) supported by program 2022:
financial product providers 6005 populate financial product database 6027 with financial product offers;
financial planning servers 2060, 2080 and financial planner 2050 populate reduced client database 2025 with reduced financial plans or strategies;
financial planning servers 2060, 2080 and financial planner 2050 query financial products database 6027 to find financial products that an individual is eligible for;
financial planning servers 2060, 2080 and financial planner 2050 send automatic financial product commitments to financial product providers 6005;
financial product demand curves are distributed to financial product providers 6005; and
new and updated financial product offers relevant to existing financial plans are distributed to financial planning servers 2060, 2080 and financial planner 2050.

MBFPS program 2021 is used by user 2010, and provides a modified benchmark financial planning system thereto.

In other embodiments, the utility functions of MBFPS 2020 operate in a separate system than the benchmark FPS functions of MBFPS 2020.

FIG. 23B shows the setup for the configuration of FIG. 23A; this figure is similar to FIG. 9 and for brevity, only differences are discussed.

At step 2100, a system administrator of system 2020 selects the time period that system 2500 will use for simulation, usually monthly, but weekly, biweekly, quarterly, semi-annually and annually are also possible.

Steps 2105, 2110, 2115 are similar to steps 700, 710, 715 of FIG. 9, discussed above.

At step 6118, financial products database 6027 is defined. A system administrator (not shown) at utility 2022 defines the types of financial products. Examples of financial product types are provided above, at the start of the section titled “FPS with automated selection of financial products”.

The system administrator of utility 2022 defines the primary features of each of the financial product types, such as description, characteristics, and lifetime in months. Then, financial product providers 6005 populate financial products database 6027 with financial product offers, see FIG. 23J.

At step 6120, the owner of each financial planning server 2080 populates supplemental financial products database 6085, in similar manner as financial products database 6027 is populated. The financial product offers in supplemental database 6085 may include hypothetical offers, discussed below.

At step 6130, the system administrator of utility 2022 and/or financial product providers 6005 populate financial products database 6027 with hypothetical financial product offers.

A hypothetical financial product offer is a way of testing market acceptance of a new financial product. Generally, a hypothetical financial product offer is the same as a non-hypothetical financial product offer, except that the hypothetical offer includes a field showing it is hypothetical. As explained below, if the MBFPS would have selected the hypothetical offer, this event is recorded, then the hypothetical offer is marked as temporarily ineligible, forcing the MBFPS to choose a non-hypothetical offer for the user's financial plan or financial strategy. The event of selecting the hypothetical offer is stored in reduced database 2025, so that when financial product demand curves are created, the demand for the hypothetical loan can be assessed.

At step 6140, the system administrator of utility 2022 defines available financial product templates. There is at least one template for each type of financial product. The template specifies cash flow configurations between the user and the financial product provider, facilitating automatic comparison of financial products from different providers. The template also defines financial product provider parameters, provided by the financial product provider at FIG. 23J step 7320, and financial product user parameters, provided by the user at FIG. 23C step 6280. Based on the template and provided parameters, at FIG. 23D1 step 6345, the MBFPS constructs financial product scenarios, fw=1 FW, representing all combinations of financial products that the user is eligible for, such as shown in Table 7. Each scenario is then simulated, see FIG. 23D1 step 6350. The scenario fw* leading to the best risk adjusted wellness metric is chosen, see FIG. 23D1 step 6365, and if using scenario fw* results in an acceptable financial strategy, see FIG. 23D1 step 2370, then it is chosen for the user's financial strategy.

For example, a financial product template for property insurance specifies monthly fixed payments from the user to provider per year, events that may trigger a payment during the insured year, and the maximum amount for each payment from the provider to the user.

The property insurance template has fields for the financial product provider to specify type of property (e.g., owned or rented, primary or other residence), location of property (state), and optional acceptable user characteristics (e.g., maximum percentage of all income that can be spent on monthly insurance payments at start of insurance; how many times a user has made reimbursement claims in the previous three years, and so on), and either a table or a formula relating monthly payments to maximum payment amount.

The property insurance template has fields for the user to specify the types of coverage desired (corresponding to the events that may trigger a payment: such as general, fire, flood, personal injury), maximum event payment from provider to user and/or maximum monthly payment. As with goals, the user may specify a range of values, not just a fixed value. When a range of values is specified, along with number of steps in the range, the MBFPS translates that into artificial values {minimum, minimum+1 step, minimum+2 steps, . . . maximum} and creates a financial product scenario for each of these artificial stepped values at FIG. 23D1 step 6345.

As another example, a financial product template for a hedge fund specifies an initial payment from the user to the provider and a final payment from the provider to the user, and return/risk level (low, medium or high).

The hedge fund template has fields for the financial product provider to specify minimum initial payment from user, minimum duration that the user must keep their money in the hedge fund, whether partial withdrawals permitted, the duration of notice that the user must provide to make a partial withdrawal, and a maximum percentage of the user's current wealth that can be directed to this hedge fund for the initial payment.

The hedge fund template has fields for the user to specify initial payment amount, that can be a range and a step amount, and a maximum percentage of their current wealth that can be directed to this hedge fund for the initial payment.

At step 6142, the system administrator of utility 2022 defines a set of personal characteristics that can be used (a) by a financial product provider to determine how to price its product for a particular user, if the provider wishes to offer prices customized by user, and (b) at step 6144 in calculating actuarial probabilities for the loss events, and other events, that are relevant to the financial products available at MBFPS 2020. Examples of personal characteristics are:
for property general insurance, the location of the property and the likelihood of claims in that neighborhood;
for property flood insurance, the distance of a property from a body of water, and the likelihood of flooding of the body of water;
for life insurance, the age of the user, their marital or relationship status, their overall state of health, the riskiness of their lifestyle, and their immediate blood relatives' ages of non-accident death;
for a high risk investment, whether the user is an accredited investor.

At step 6144, the system administrator of utility 2022 defines the actuarial loss probability threshold ULT[e], for events e=1 . . . E, used in FIG. 23D3 step 6316 to simulate loss events. An actuarial probability is a future probability, estimated by an actuarial professional person, in view of a history of occurrences. In its simplest form, a threshold ULT[e] is a fixed number. In more sophisticated form, a threshold ULT[e] depends on characteristics relevant to the event. Here, the available characteristics were defined at step 6142.

At step 6146, the system administrator of utility 2022 defines the monetary value of an actuarial loss event EV[e], e=1 . . . E, used in FIG. 23D5 step 6351. In its simplest form, a monetary value EV[e] is a fixed number. In more sophisticated form, a monetary value EV[e] depends on characteristics relevant to the event. Here, the available characteristics were defined at step 6142. Examples of loss events include property damage, car accidents, medical emergencies (heart attacks, cancer and other debilitating conditions), and so on. Examples of relevant characteristics are: for property damage, the value of the property; for car accident, how many car trips the user takes per months; and for medical emergencies, the user's overall health and family history of medical emergencies.

At step 2150, the system administrator of FPS 2020 (not shown) defines available FS periodic acceptability criteria for the period defined at step 2100, to assist in modeling what is important to a user. The FS periodic acceptability criteria are evaluated at each period t of the FS. In some embodiments, the FS periodic acceptability criteria can change during the FS, as the user's interests change, such as appetite for risk. In this embodiment, only one FS periodic acceptability criteria can be selected, but in other embodiments, multiple FS periodic acceptability criteria can be simultaneously selected. Examples of FS periodic acceptability criteria are shown in Table 8.

TABLE 8
Financial strategy periodic acceptability criteria

| Short Name | Parameters | Description |
|---|---|---|
| None | — | Rely on the benchmark curve alone, do not |
| | | eliminate any financial product scenarios |
| Liquidity cushion | m | Require cash cushion of m months of |
| | | expenses, with expenses based on average |
| | | for current and previous years |
| Loan affordability | fp | Sum of user's loan payments must be less |
| v. paycheck | | than fp % of user's monthly paycheck |
| Loan affordability | fa | Sum of user's loan payments must be less |
| v. disposable | | than fa % of user's entire annual income |
| income | | less housing payments, if any |
| Minimum savings | sp | User's savings from income must be at least |
| percent | | sp % of user's income |
| Minimum savings | sam | User's savings from income per month must |
| amount per month | | be at least sam |

For instance, if a user selects (liquidity cushion, m=12), MBFPS 2020 will require that the user's FS has at least 12 months of expenses available as cash.

At step 6160, the system administrator of FPS 2020 (not shown) defines parameters relating to financial products and bankruptcy, including for the risk adjusted wellness metric RAWM discussed below, weights for the goal priority levels (e.g., 0.8, 0.5 and 0.2 for three priority levels), and a weight for the importance of the bankruptcy probability.

FIG. 23C shows the user registration for MBFPS 2020; this figure is similar to FIG. 10 and for brevity, only differences are discussed. Steps 2220-2240 of FIG. 23C are similar to steps 720-740 of FIG. 10. The steps of FIG. 23C are performed by the appropriate one of benchmark FPS program 2021 of system 2020, financial planner 2050, financial planning server 2060 and financial planning server 2080 (henceforth collectively referred to as “FPS 2021”), except for step 2299.

At step 2201, FPS 2021 assigns a unique ID tag to the user, for use in the reduced FS.

At step 6235, in addition to defining their liquidatable assets, the user chooses whether to override the default method of determining their solvency threshold and other parameters relating to bankruptcy, see discussion of FIG. 23D6 step 6355. In this embodiment, assets can be liquidated to achieve a goal, see FIG. 23F, or to prevent bankruptcy, see FIG. 23D6.

At step 2245, the user selects FS acceptability criteria: a success of financial strategy threshold (SFS-TH), and success weights SWeight_p for each priority level p=1 . . . P, used to automatically determine whether a FS is acceptable. The success weights must sum to 1.0. For example, if the user has only high and low priority goals, then SWeight_high+SWeight_low=1. At FIG. 23D step 2370, the MBFPS uses SFS-TH and SWeight_p to automatically determine whether to accept a FS.

Steps 2250-2270 of FIG. 23C are similar to steps 750-770 of FIG. 10.

At step 6275, the user can change the default order for selecting financial products available to that user. The default order of selection, assuming that all other characteristics of the financial products are equal, in order of preference, is: supplemental, hypothetical, third-party.

At step 6280, the user selects acceptable financial product templates from the financial product templates defined at step 6140 of FIG. 23B, and optionally customizes their parameters.

At step 2285, the user selects from among the available FS periodic acceptability criteria defined at step 2150 of FIG. 23B and provides parameters as needed.

At step 2290, the user selects from among the available FS scenario-best criteria defined at step 6160 of FIG. 23B.

At step 6295 the user decides whether to opt in to automatic financial product approval. The default is no automatic financial product approval, which can be changed by the user.

At step 6297, the user selects whether s/he wants to be advised of financial product early termination opportunities, and if so, selects a threshold PPAY-TH. See FIG. 23G step 2630.

Step 2299, providing a general research interface, is performed by utility program 2022. This step is shown with dotted lines to indicate that it is optional. The general research interface is typically a graphical user interface (GUI) that presents a start page with a menu such as in Table 9.

TABLE 9
General Research GUI, MBFPS, Financial Products
General Research

Help

Data structure of financial product offers
Statistics for financial product offers
Financial product provider information
Financial product offers

The user can access the General Research GUI after s/he has sufficiently provided registration information. The General Research GUI is a user-friendly way to browse the contents of financial product database 6027. The user positions his/her cursor over an item on the start page and clicks on it, to get to another page. The menu items function as follows:
Help—provides information on how to use the General Research GUI;
Data structure of financial product offers—lets the user browse the financial product structure defined in step 6118 of FIG. 23B, to get a map of the information available at the “Financial product offers” menu item;
Statistics for financial product offers—lets the user see statistics for commensurate financial product offers in database 6027. For each type of financial product, statistics can be viewed such as:
   number of financial product offers in database 6027,
   the appropriate terms for each financial product offer in database 6027; it will be appreciated that the terms for an annuity differ from those for property insurance.
Financial product provider information—lets the user browse user-visible marketing information about financial product providers 6005 optionally provided by the providers 6005 in financial products database 6027, when the providers registered (see FIG. 23J step 7310). Typically, the provider populates its user-visible marketing information when it is prepared to communicate directly with users, such as to provide more details about its financial product offers or, on a case-by-case basis, consider whether to extend its financial product offer to a user that does not meet its customer criteria in database 6027;
Financial product offers—lets the user browse the financial product offers available in financial product database 6027. Typically, the user quickly gets overwhelmed in trying to manually compare the financial product offers, and is then far more appreciative of the convenience of using MBFPS 2020. Generally, the user selects a financial product type from among the financial product types specified at step 6118 of FIG. 23B, then selects values or value ranges for the characteristics defined at step 6140 of FIG. 23B, and utility program 2022 responds with the appropriate financial product instances.

FIG. 23D, comprising FIGS. 23D1-23D6, shows the operation of MBFPS 2020; this figure is similar to FIG. 11A and for brevity, only differences are discussed.

Step 6310 of FIG. 23D1 is an augmented version step 810 of FIG. 11A. For each time period t of each simulation run n, at step 6312, for each type of market rate j, the scenario exogenous rates SER are simulated (see FIG. 23D2); for each type of loss event e, the chance of a loss event is simulated (see FIG. 23D3); and for each investment v, the scenario investment returns SIR are simulated (see FIG. 23D4).

Turning to FIG. 23D2, the market rates correspond to respective rates typically used in finance, such as the Fed Funds rate, inflation, the US 5 year borrowing rate, the US 10 year borrowing rate, the Prime rate, the 11th District Cost of Fund Index (COFI), or the Dow Jones Industrial Average. All the reference rates, such as the Prime rate, are simulated so that the effects of financial product payments and pay-outs depending on these rates can be estimated at FIG. 23D3 step 6351. The market rates j=1 . . . J are assumed to follow a Gaussian distribution. At step 6313, a random number, between 0 and 1, following a Gaussian distribution is generated, and SER[n,t,j] is set based on the generated number, then stored. For example, the Dow Jones Industrial Average, a weighted average of 30 stocks, is currently about 35,000. Assume that a possible value for the Dow is between 10,000 and 100,000 with a mean of 35,000. The Gaussian generated number is mapped into the possible values so that Gaussians of 0, 0.5, 1 respectively correspond to SER of 10,000, 35,000, 100,000. Thus, at n=1 (the first simulation run), t=20 (the twentieth month), j=3 (the third market rate: the Dow), if the Gaussian number 0.45 is generated, SER[1,20,3]=35,000−(0.5−0.45)*(35,000−10,000)=33,750.

Turning to FIG. 23D2, loss events include exogenous events, such as but not limited to a market crash, terrorist attack, flood, or pandemic; and personal events, such as but not limited to serious medical problem, divorce, death of a spouse or child, job termination. At step 6316, the loss event threshold ULT[e] for each type of loss event e=1 . . . E, established at FIG. 23B step 6144, are retrieved. A random number between 0 and 1, with uniform distribution, is generated. If the random number is below ULT[e], then the loss event UL[n,t,e] is set to “0”. If the random number equals or exceeds ULT[e], then the loss event UL[n,t,e] is set to “1”. The loss event array UL[n,t,e] is stored. Most of this array is zero, because loss events rarely occur.

Turning to FIG. 23D4, the processing corresponds to step 810 of FIG. 11A.

Returning to FIG. 23D1, step 6320, determining the benchmark, is shown in FIG. 23E.

FIG. 23E is similar to FIG. 11, except that at step 6420, the priority is set to 0, corresponding to no goal spending but only expense spending. In this embodiment, MWAG P0 is used as the solvency threshold, see FIG. 14, so it is convenient to determine the solvency threshold here. In other embodiments, something else is used as the solvency threshold, so there is no need to calculate MWAG P0.

Returning to FIG. 23D1, step 6345, determine available financial product scenarios, uses the financial product templates selected at step 6280 of FIG. 23C, and the financial product offers stored in database 6027, to generate suitable financial product scenarios fw=1 . . . FW. Examples of generating financial product scenarios are discussed above and shown in Table 7. These financial product scenarios are used at step 6350.

Step 6350, running the simulations, is shown in FIG. 23D3. A set of simulations includes at least 100 simulation paths (N=100), each simulation path having at least 60 time periods (T=60, corresponding to five years), resulting in 600 periods for which user's wealth is determined. Typically, a set of simulations includes around 1,000 simulation paths (N=1000), each simulation path having 300 time periods (N=300, corresponding to 25 years), resulting in 300,000 periods for which user's wealth is determined. If a user is about 20 years old, then a typical set of simulations will involve 1,000 simulation paths and 600 time periods (corresponding to 50 years), resulting in 600,000 periods for wealth determination. Because of the voluminous number of calculations involved in creating a set of simulations, it is impractical to manually calculate the set of simulations, that is, using a computer is the only practical way to create a set of simulations.

Turning to FIG. 23D5, at step 6351, the outermost loop is performed for each financial product (financial widget) fw in the FW scenarios. Evaluation of a sub-goal in the (n, t, p, s) innermost loop is shown in FIG. 23F.

Turning to FIG. 23F, evaluation of a sub-goal, corresponding to the (fw, n, t, p, s) innermost loop of step 6351 in FIG. 23D5 is explained. At step 6535, the MBFPS compares current wealth B[n,t−1] with the appropriate benchmark Benchmark_p_s.

If wealth is sufficient to achieve the sub-goal, then processing continues to step 2555.

If wealth is too small to achieve the sub-goal, then at step 2540, it is determined whether permitted asset liquidation could provide enough wealth to achieve the goal. If not, the sub-goal cannot be achieved at this point, and processing returns to FIG. 23D5.

If asset liquidation will enable achieving the sub-goal, at step 2545, assets are liquidated, and at step 2550, the previous wealth balance is increased due to the asset liquidation, thus providing enough wealth to achieve the sub-goal.

At step 2555, FPS 2021 marks the affordable goal as being committed in the FS, i.e., the goal has been converted to a life action, and processing returns to step 6351 of FIG. 23D5.

Returning to FIG. 23D5, at step 6351, the investment weights w[n,t,k] are determined based on the current savings balance B[fw,n,t−1], the benchmark curve and the weights w[n,t−1,k] for the selected strategy; and the net savings NS[t] and Portfolio Return PR[n,t] are determined, as discussed with respect to FIG. 11B step 850.

For loss events e=1 to E, the following occurs:
the event cash flow ECF[fw,n,t,e] is determined by multiplying the loss event simulation UL[n,t,e], a zero or one determined at FIG. 23D3 step 6316, by the expected value of the loss event EV[e], an actuarial value determined at FIG. 23B step 6146. ECF[fw,n,t,e] is either zero, if no loss occurred, or the actuarial dollar value of such loss suffered by the user.
the financial product cash flow WCF[fw,n,t] is determined based on the provider's parameters defined in FIG. 23J step 7320, appropriate market rates SER[n,t,j] that were included in the definition of FIG. 23J step 7320, and the loss amount ECF[fw,n,t,e]. The financial product cash flow includes payments from the user to the financial product provider, and if a loss occurred, may include payments up to the value of the loss amount, in accordance with the definition of FIG. 23J step 7320. In many cases, if a loss occurred, it is not totally reimbursed due to deductibles defined at FIG. 23J step 7320.
the financial product estimated rate of return FWERR is determined as the internal rate of return for the financial product cash flow WCF:

$$0 = {\sum }_{t = 0}^{T} ( WCF [ t ] - UCF [ t ] ) / {( 1 + FWERR )}^{t} \qquad ( equation 23 )$$

where WCF[t]=payments from provider to user during time t
UCF[t]=payments from user to provider during time t
FWERR=the value to be determined

After FWERR is estimated, the user's wealth balance B[fw,n,t] at this point in the simulation is computed and stored. The wealth balance B[fw,n,t] is the sum of: the previous interval's balance B[fw,n,t−1] times the portfolio return PR[n,t] at this interval, plus the user's net savings NS[t] during this interval, plus the event cash flow ECF[fw,n,t,e] during this interval, plus the financial product cash flow WCF[fw,n,t] at this interval.

Then, a bankruptcy check is performed at step 6354, shown in FIG. 23D6.

Turning to FIG. 23D6, at step 6355, MBFPS 2021 compares the user's current wealth balance B[fw,n,t], determined in FIG. 23D5 step 6351, to a solvency threshold. The solvency threshold, an amount where the user feels financially secure, is set at step 6235 of FIG. 23C. In one embodiment, the user selects their solvency threshold ST from one of:
ST[t]=MWAG_P1[t], meaning that the user is determined to achieve their priority 1 goals.
ST[t]=MWAG_P0[t], where MWAG_P0[t] is a benchmark assuming that the user achieves none of their goals. This is a liberal approach and is the default for the solvency threshold, as shown in FIG. 14.
   At step 6235 of FIG. 23C, in some embodiments, the user is able to override the default parameters for financial products and bankruptcy that were provided at FIG. 23B step 6160.

If the comparison of step 6355 is that B[fw,n,t] exceeds ST[t], then there is no problem, and processing returns to FIG. 23D5.

If the comparison of step 6355 is that B[fw,n,t] is less than ST[t], then the user is projected to encounter bankruptcy in the future. In this embodiment, there are four “tools” that may help the user avoid bankruptcy:
Reducing expenses. Any expenses relating to committed goals may be able to be reduced. First, the MBFPS checks if there is a penalty associated with reducing payments, if so, that is offset against possible savings from satisfying the goal in a cheaper manner. It will be recalled that users can specify goal value and timing ranges, and this is where replacing a committed goal with a similar less costly version may occur.
Eliminating expenses. This is similar to reducing expenses, but here, the committed goal is uncommitted, and remains unsatisfied at this time. If there is still time to satisfy the goal in future, then it is added to the user's goals. Otherwise, it becomes a goal that could not be achieved.
General loans. A general loan is a financial product that is not tied to a goal. Financial product providers are encouraged to offer a variety of general loans, and can specify terms such as prepayment penalties, whether the loan must be secured by assets, and whether only users having above a threshold of wealth are eligible. Combinations of general loans may be the best fit for a particular user. The MBFPS assumes that the user is willing to obtain a general loan to avoid bankruptcy, but if the user is averse to general loans, the user can specify, at FIG. 23C step 6235, that general loans cannot be considered.
Liquidating assets. A user's current wealth may be able to be increased by selling assets. In this embodiment, loans are preferred to selling assets, because assets may have sentimental value, or the need for quick liquidation may reduce the funds that can be obtained.

Reducing expenses, eliminating expenses and liquidating assets are considered to be austerity measures.

The embodiment of FIG. 23D6 shows the four tools for avoiding bankruptcy being evaluated separately. In other embodiments (not shown), combinations may be considered, such as reducing expenses and obtaining general loans.

At step 6370, MBFPS 2021 checks whether the committed goals can be replaced by cheaper goals, and if so, whether the expense reduction will make B>ST. If yes, then at step 6372, the expenses (committed goals) are reduced, and processing continues at step 6398.

At step 6374, MBFPS 2021 checks whether the user qualifies for any general loans. If so, at step 6375, the general loan scenarios gL=1 to GL are determined, similar to determining the financial product scenarios as explained above with respect to Table 7. Then, at step 6376, MBFPS 2021 checks whether the sum of the loans in a general loan scenario gL is sufficient to make B>ST, and if so, the scenario gL is stored.

At step 6377, after evaluating all general loan scenarios, MBFPS 2021 checks whether any of them made B>ST. If so, at step 6378, the cheapest scenario is selected for this simulation path and processing continues at step 6398.

If each of reducing expenses and general loans could not rescue the user, then at step 6390, MBFPS 2021 checks whether eliminating committed goals will make B>ST. If yes, then at step 6372, the expenses (committed goals) are reduced, and processing continues at step 6398.

Finally, if none of the previous three tools worked, at step 6394, MBFPS 2021 checks whether the user has sufficient liquidatable assets, specified at FIG. 23C step 6235, to make up the shortfall in B[fw,n,t] relative to ST[t]. If so, then at step 6396, appropriate assets are liquidated, and processing continues at step 6398.

At step 6398, the user's current wealth B[fw,n,t] is adjusted (increased) to reflect the prophylactic action(s) taken, and processing returns to FIG. 23D5.

In another embodiment (not shown), the user specifies their monthly expenses as “need” or “discretionary”, and the austerity phase halts discretionary spending to reduce the user's expenses, until the user remains above their solvency threshold if discretionary spending occurs.

If the decision at step 6394 is that liquidating assets is insufficient to keep the user solvent, then at step 6399, MBFPS 2021 determines that the user is bankrupt and abruptly terminates this simulation path for fw and n, and processing returns to FIG. 23D5 for the next path fw and n+1 of the simulation.

Returning to FIG. 23D5, the investment account is rebalanced, taxes for the next period [t+1] are adjusted, and the current wealth is stored.

Returning to FIG. 23D1, at step 6360, the goal success likelihood GSL_p for each goal priority level p is determined, and the risk adjusted wellness metric RAWM is determined. Consistent with FIG. 10 step 745, GSL_p is the likelihood over all simulations that the wealth at the last simulation period T exceeds the benchmark for that priority level, see Equation 15A, a modified form of Equation 15 that shows a variation of the BFPS acceptability test, where the function 1(.) has value 1 if true and 0 if false:

$$GSL \_ p = \frac{1}{N} * {\sum }_{n = 1}^{N} 1 ( B [ fw , n , T ] > Benchmark\_ p ) \qquad ( equation 15 A )$$

The risk in the RAWM is distinct from the risk discussed above for FIGS. 18-20.

The RAWM is a metric increased by goal achievement and decreased by bankruptcy. For instance,

RAWM=WGA−w_{bkrpt}*PR(BKRPT) (equation 24)

Weighted goals achievement WGA, a number between 0 and 1, is the weighted average of individual goal achievement probabilities with weighting assigned based on the priority of the goal, such as 80% weight for high priority, 50% weight for medium priority, and 20% weight for low priority goals. The weight w_{bkrpt}, a number between 0 and 1, indicates the importance of Pr(BKRPT) relative to WGA. The probability of bankruptcy Pr(BKRPT), a number between 0 and 1,is the likelihood of bankruptcy across all simulation scenarios. Specifically, for these exemplary weights, chosen at FIG. 23B step 6160:

$$\begin{matrix} WGA = \frac{{\sum }_{g = 1}^{G} \begin{matrix}0.8 * Pr ( Goal\_priority1 \_ g ) + \\ 0.5 * Pr ( Goal\_priority2 \_ g ) + \\ 0.2 * Pr ( Goal\_priority3 \_ g )\end{matrix}}{{\sum }_{g = 1}^{G} \begin{matrix}0.8 * 1 ( goal g has priority 1 ) + \\ 0.5 * 1 ( goal g has priority 2 ) + \\ 0.2 * 1 ( goal g has priority 3 )\end{matrix}} \\ where Pr ( Goal\_priority x \_ g ) = \frac{( No . simulation paths where goal g achieved )}{( total no . simulation paths )} & ( equation 25 ) \\ and & \\ Pr ( BKRPT ) = \frac{1}{N} * {\sum }_{n = 1}^{N} 1 ( path n has bankruptcy ) & ( equation 26 )\end{matrix}$$

At step 6365, MBFPS 2021 determines the RAWM for all the financial product scenarios, orders the scenarios from best to worst according to their RAWM, and selects the financial product scenario fw* having the best RAWM. This is the determination of which financial product or combination of financial products should be in the user's FS, if any. Because the selection is made to optimize RAWM, the least cost product is not always chosen, as more expensive products may have characteristics that better suit the user's situation.

At step 7370, MBFPS 2021 determines whether the FS is acceptable by comparing the success of a financial strategy (SFS) metric with the threshold SFS-TH defined at step 2245 of FIG. 23C, i.e., checks whether SFS>SFS-TH, where SFS is the weighted average of the GSL for the goals at each priority level p=1 . . . P, with the weight depending on the priority level, as shown in Equation 27.

$$SFS = {\sum }_{p = 1}^{P} ( S Weight\_ p * \frac{1}{N} * {\sum }_{n = 1}^{N} 1 ( B [ fw , n , T ] > Benchmark\_ p ) ) \qquad ( equation 27 )$$

Instead of a vector of FS acceptability thresholds, Acceptability_p, p=1 . . . P for each priority level, as used in the benchmark FPS of FIGS. 5-12, in this MBFPS, the user specifies one FS success threshold SFS-TH and goal success likelihood weights for each priority level, SWeight_p, p=1 . . . P. In other embodiments, FS acceptability is determined differently. Step 7370 is a test that automatically determines acceptability of the FS. If the FS is acceptable, processing continues at step 7373.

If the FS is not acceptable, then at step 7371 MBFPS 2021 selects as fw* the financial product scenario with the next best RAWM and returns to step 7370 to determine whether a FS based on this new fw* is acceptable based on its SFS.

When, at step 2371, MBFPS 2021 determines that all financial product scenarios have been checked for acceptability, including the first scenario that always has no financial products, and none are acceptable, processing continues at step 2375.

In some embodiments, if fw* is the scenario with no financial products, and is unacceptable, then processing immediately continues at step 2375, even if there are other scenarios remaining to be tested for acceptability. The RAWM acceptability criteria might need to be adjusted at step 2375.

General acceptability can be defined as a grand function of all information generated during the simulation, a “general utility function” GU(*). SFS is a particular embodiment of GU. Other possible embodiments include for example value-weighted SFS, which also incorporates the value of the goals and not only their success likelihoods GSL (an example of which is shown later in the Wellness Score discussion). Yet another embodiment may be related to a notion of expected path-wise utility PU(n) set equal to aggregate consumption achieved along a given simulation path, averaged over all Monte Carlo paths.

At step 7373, MBFPS 2021 checks whether any hypothetical financial products are present in the financial product scenario fw*. If so, at step 7374, MBFPS 2021 stores the event of a hypothetical financial product being selected, disqualifies this scenario fw* because it includes a hypothetical financial product, and processing continues at step 7371.

If, at step 7373, MBFPS 2021 determines there are no hypothetical financial products in the scenario fw*, then a best FS strategy—a FS that is acceptable and has the best RAWM—has been determined, and processing continues at step 6380. Step 2372, occurring after the FS is determined, for providing a personal research interface, is similar to step 2299 of FIG. 23C, except that the user can also query information relating to his/her FS, provided by FPS 2021.

The personal research interface is typically an interactive graphical user interface (GUI) that presents a start page with a menu such as in Table 10.

TABLE 10
Personal Research GUI, Benchmark FPS with Financial product
Personal Research

```
Help
Data structure of financial product offers
Statistics for financial products offers
Financial product provider information
Financial product offers
More data structure
    Investments and risk parameters
    System strategies (selected investments and weights)
    Life Action templates
    Goal templates
    Financial product templates
    Lifetime acceptability criteria
    Periodic acceptability criteria
Your financial strategy set-up information
    Account information
    Life Actions
    Goals
    Liquidatable Assets
    System strategies
    Financial plan acceptability criteria
    Accounts with third party systems
    Financial product templates
      Periodic acceptability criteria
    Automatic loan approval
Your financial strategy
      Financial strategy
    Benchmark
    Financial product offers that you were eligible for
    Assets liquidated to achieve financial strategy
    Goals success likelihood
    Simulated bankruptcy rate
    Success weights, Success threshold, Success of Financial Strategy
Dual Goal Sensitivity Analysis
Single Goal Sensitivity Analysis
```

Other than the first five menu items that function as described with respect to step 2299 of FIG. 23C, the menu items function as follows:
More data structure—lets the user examine the information provided at steps 2105-2115 and 6140, 2150 and 6160 of FIG. 23B;
Your financial strategy set-up information—lets the user examine the information provided by the user and FPS 2021 in FIG. 23C;
Your financial strategy—lets the user examine the following:
   Financial strategy—the financial strategy created at step 6350 and its metrics for each period such as liquidity cushion (minimum, maximum, average, median across the N simulations);
   Benchmark—the benchmarks for each priority determined at step 2320;
   Financial product offers that you were eligible for for the eligible scenarios of step 6345;
   Financial product offers that you were not eligible for at step 6345, with an explanation of why the user was ineligible, such as the user failed to satisfy the lender's user criteria with the unmet criteria identified;
   Financial product comparison—if the user wishes, the FPS generates a table comparing financial product offers selected by the user;
   Assets liquidated for financial strategy—the assets confirmed for liquidation for each period across the N simulations at step 6560 of FIG. 23F;
   Goals success likelihood—as determined at step 2360;
   Simulated bankruptcy rate—as determined at step 2360;
   Success weights, Success threshold, Success of Financial Strategy—as used and determined at step 2370;
Dual Goal Sensitivity Analysis—lets the user plot goal likelihoods against each other for two goals, as described below. This is particularly useful when a FS is not acceptable, for manually tweaking at step 2375;
Single Goal Sensitivity Analysis—lets the user how the likelihood of achieving a goal will change as the cost of the goal is varied, see below. This is also helpful for manual tweaking at step 2375.
   The Personal Research GUI also lets the user save and retrieve (not shown) his/her FS information, sensitivity analyses and goal sensitivity analyses.

Dual Goal Sensitivity Analysis and Single Goal Sensitivity Analysis are discussed in the parent application.

At step 6380, FPS 2021 stores the selected fw* and the corresponding WCF[fw*,n,t] and checks whether any of the financial product offers chosen for the FS have acceptance time constraints, indicated as “Financial product (t)” to distinguish from a financial product lacking an acceptance time constraint. For instance, a financial product provider may offer a financial product at a special rate if the borrower pays something by a first date to lock in the special rate, then uses the financial product by a second date. This helps financial product providers forecast product demand. If not, processing continues at step 2390, since if no financial product has an acceptance time constraint, then financial products may be in the user's FS, and commitments will occur when the financial products are needed.

If a selected financial product has an acceptance time constraint, then at step 2382, FPS 2021 prepares information as to how not accepting (committing to) this financial product affects the user's FS, specifically, (i) whether there are similar financial product but slightly more expensive and devoid of acceptance time constraints that can be easily substituted with no other changes to the user's FS, and (ii) whether not accepting the financial product with a time constraint would block the user from achieving a goal

At step 6384, financial product commitment processing as shown in FIG. 23H occurs. The user will be asked if s/he wishes to approve the financial product and will be presented with the alternatives information prepared at step 2382. Since accepting a financial product changes the user's situation—different wealth at some time, a new liability, and need to make repayments—at step 2386, the FS is updated. If at least one financial product commitment does not occur at step 2384, then updating the FS at step 2386 is skipped.

At step 2390, the user's FS has been determined. FPS 2021 stores the FS in one of client database 2024, 2064, 2083.

At step 2392, FPS 2021 stores a reduced (anonymized) form of the FS in reduced database 2025, including the event of a hypothetical financial product being selected, if any, that was stored at FIG. 23D1 step 7374.

Step 2395, applying the financial strategy, is shown in FIG. 23G.

FIG. 23G shows detail of step 2395 of FIG. 23D1, “apply financial strategy”; this figure is similar to FIG. 11C and for brevity, only differences are discussed. Applying the FS means (i) taking actions in view of the user's goals and the market environment at the previous time interval, (ii) updating the values reflecting the market environment, and (iii) determining a new FS if needed.

At step 2630, based on the FS and market conditions, FPS 2021 may suggest actions such as rebalancing an investment portfolio or liquidating assets, or. FPS 2021 automatically checks whether financial product prepayment is feasible. If a user's income has increased, such as via inheritance, job promotion or investment performance, or expenses have decreased, so that B[n,t−1]−Benchmark>PPAY-TH, where PPAY-TH is defined at FIG. 17C step 2297, then FPS 2021 presents the user with this situation, advises whether there are financial product prepayment penalties, so the user can decide whether to increase the financial product payment for this period, and by how much. Depending on the financial product terms, if excess payment is made, FPS 2021 adjusts the financial product's payment for future periods.

At step 6635, FPS 2021 determines whether to automatically commit to a financial product, as shown in FIG. 23H. It will be recalled that financial products with acceptance time constraints are considered for commitment at step 6380 of FIG. 23D1. Typically, a user wants to postpone committing as long as possible, in case circumstances change, but could be persuaded to commit early by a good offer.

At step 6655, if a loss event has occurred, the user notifies MBFPS 2021 of the type of loss event, the actual amount of the loss ECFA and any related payments actually received from a financial product provider WCFA, and this information is stored. For this figure, regular payments from the user to the financial provider are represented by WCF[fw*,t].

At step 2680, if notice of a new or revised financial product offer was received, see “BB” circle in FIG. 23D1, then processing continues at FIG. 23D1 step 6320, see “AA” circle.

At step 6690, the actual event cash flow ECFA and actual financial product payments received WCFA are retrieved from storage, instead of using simulated ECF and WCF. Current wealth B[⋅] is based on the selected financial plan scenario fw*. The processing for step 2695, evaluate sub-goal, is shown in FIG. 23F. The processing for step 6698, bankruptcy, is shown in FIG. 23D6.

FIG. 23H shows the automated financial product commitment detail of step 6635 of FIG. 23G.

At step 6705, FPS 2021 checks whether there is a financial product in the FS. If not, processing is complete. If there is at least one financial product, processing proceeds to step 6710.

At step 6710, appropriate ones of software 2021, 2052, 2060, 2081 checks whether the user and the financial product provider have both authorized automatic financial product commitment. If no, processing continues at step 6725.

If the user and lender have authorized automated loan commitment, at step 6720, appropriate ones of software 2021, 2052, 2060, 2081 sends financial product commitments to the appropriate financial product providers, and processing is complete.

In some embodiments, a financial product commitment specifies how binding it is, depending on the preferences of the provider and user. Financial product commitment “binding-ness” is one of the financial product characteristics. For instance, a financial product commitment can be in one of three “binding-ness” flavors:
indication of interest—the provider can stop offering this type of loan at any time, and the user can change his/her mind at any time;
most favored nation—the provider will give the user at least thirty days notice if it decides to stop offering this loan, and the user will give the provider at least fifteen days to match a better commensurate product offer from another provider;
binding—the provider and the user each agree to a financial penalty if they will not enter into the financial product.
   When a provider creates a financial product offer at step 7320 of FIG. 23J, the lender can specify acceptable commitment “binding-ness” flavors. When an individual receives a new financial product offer, the software considers the “binding-ness” of the existing financial product in deciding whether to replace the existing financial product with the new financial product.

If the provider has authorized automated financial product commitment, but the user has not authorized automated financial commitment, at FIG. 23H, step 6725, appropriate software asks the user if s/he wishes to commit to a selected financial product, and receives the user's response.

At step 2730, appropriate software checks whether the user has approved committing to the financial product. If not, processing is complete. If the user has approved, processing proceeds to step 6720.

FIG. 23 shows the operation of benchmark utility software 2022 to create financial product demand curves for the modified benchmark financial planning system with automatically selected financial products.

At step 2810, utility program 2022 checks whether it is time to create financial product demand curves, such as by comparing a timer of the current elapsed time t_elapsed to a threshold T_threshold. If it is not yet time, utility program keeps checking while incrementing t_elapsed as time passes. Eventually, it will be time to create, and processing proceeds to step 6815.

At step 6815, for each type of financial product, as defined at step 6118 of FIG. 23B, at step 6820, utility program 2022 retrieves the financial plans from reduced storage 2025 that include this type of financial product and also retrieves the events where hypothetical financial products of this type would have been chosen as stored as step 2545 of FIG. 23F. These financial plans can be depicted in a chart as in FIG. 18.

At step 6830, utility program 2022 then constructs a financial product demand curve, as in FIG. 20, based on the retrieved financial plans. Generally, utility program 2022 creates the following loan demand curves and distributes as follows:
Without hypotheticals (based only on actual FP information), distributed to all financial product providers 6005;
Hypotheticals defined by system administrator of MBFPS 2020, distributed to all financial product providers 6005; and
Hypotheticals defined by a specific financial product provider 6086, distributed only to that provider.
   Comparing a hypothetical offer with the non-hypothetical offers lets a financial product provider quickly determine how popular the hypothetical offer would be. This is an extremely quick and inexpensive form of market research for a financial product provider.

At step 6835, utility program 2022 sends the various types of loan demand curves to those of financial product providers that either offer this type of loan, or have indicated interest in offering this type of loan.

If an entity offering supplemental financial products wishes to see the loan demand curves for third-party loans, it must register as an instance of financial product provider 6005 and indicate interest in offering this type of loan.

At step 6855, utility program 2022 receives the revised and new financial products, if any.

At step 6860, utility program 2022 updates financial products database 6027 with the revised or new financial products.

At step 6865, utility program 2022 notifies the software, selected from software 2021, 2052, 2081, associated with the relevant financial plans, i.e., the financial plans retrieved at step 6820, of the revised or new loan terms. FIG. 23D1 indicates that, at step 2395, the notice from step 1865 may trigger revising an existing financial product scenario or determining a new financial product scenario, and if appropriate, updating the financial plan

At step 2870, utility program 2022 sets the timer t_elapsed to zero, and processing returns to step 2810.

In some embodiments, software 2081 executes steps 2810, 6815, 6835, 6860, 6865, 2870 for the financial plans in client database 2083, to produce supplemental financial product demand curves for its customers. These supplemental financial product demand curves are proprietary to the owner of FPS 2080.

FIG. 23J shows set-up for financial product provider 6005.

At step 7300, financial product provider 6005 opens an account with utility system 2022, provides contact information and demonstrates its authorization to act as a financial product provider (if needed), along with optional information such as the total amount and/or number of financial products it is willing to provide via MBFPS 2022, the total daily amount and/or number of financial products it is willing to provide via MBFPS 2022.

At step 7310, financial product provider 6005 provides user-visible marketing information, such as address, customer service telephone number, and why a user should feel comfortable getting a financial product from provider 6005. Provider 6005 can also designate some or all of the information it provides at step 7320 as being user-visible.

At step 7320, for each financial product instance, provider 6005 defines its features, such as description, parameters, product applicability (e.g., types of homes for home insurance) and required customer characteristics. Customer characteristics are selected from:
information maintained in customer database 2024, 2064, 2055, 2083, for each customer, such as income and assets,
information computed for each customer, such as percent of income devoted to other items; and information that provider 6005 obtains from information service 40, such as a FICO score.

At step 7320, financial product provider 6005 can choose a customer creditworthiness characteristic determined by FPS 2021 that changes during the lifetime of the FS, as the user's simulated incomes, expenses, assets, liabilities and wealth change. In this case, the FPS 2021 performs an initial calibration procedure to determine the parameters of the model for predicting changes in creditworthiness and for predicting associated changes in user-specific rate adjustments. This calibration can be done by estimating the current creditworthiness of multiple users and comparing it with lender-estimated user-specific rates adjustments for such users, in a cross-sectional model fitting procedure. After the calibration step is completed, the parameters of the creditworthiness model are saved and used for future estimates and simulations.

At step 7330, financial product provider 6005 can optionally opt into automatic financial product approval when borrowers meet all its criteria, and the financial products are within the daily and lifetime limits, if any, defined at step 7300. In some embodiments, automatic financial product approval can be conditioned on additional information, such as different thresholds for customer characteristics. For example, a provider may be willing to sell its financial product to someone with an income of at least $30,000, and be willing to automatically sell to someone having income of at least $100,000.

At step 7335, notice of the new financial product offer is provided to step 6855 of FIG. 23I, and at step 6860 of FIG. 23I, the new product offer is stored in financial products database 6027 of MBFPS 2020 in FIG. 23A.

FIG. 23K shows operation for financial product provider 6005.

At step S410, financial product provider 6005 can modify the information it provided at step 7300 of FIG. 23J.

At step S420, financial product provider 6005 can modify the information it provided at step 7310 of FIG. 23J.

At step 7430, financial product provider 6005 can add a new financial product. When this occurs, MBFPS 2020 automatically distributes (not shown) information about this new financial product to users whose financial plans or financial strategies include a similar type of financial product.

At step 7440, financial product provider 6005 can amend the terms of an existing financial product or delete the financial product entirely.

At step 7450, if financial product provider 6005 has opted into automatic loan approval at step 7330 of FIG. 23J, MBFPS 2020 informs financial product provider 6005 that financial product provider 6005 has just agreed to sell a financial product.

At step 7460, financial product provider 6005 receives the loan demand curve from utility program 2020 that was sent at step 6835 of FIG. 23I.

At step S470, financial product provider 6005 decides whether to offer revised or new financial products based on the loan demand curve. Usually, a product manager employed by financial product provider 6005 reviews the loan demand curve, and decides how to respond.

At step 7480, if financial product provider 6005 has decided to offer a revised or new loan product, financial product provider 6005 sends the financial product terms to utility program 2022, received at step 6855 of FIG. 23I. Or, financial product provider 6005 can separately offer revised or new loan products via steps 7430 and 7440.

The embodiment of FIG. 23 provides at least the following advantages to a user:
automatically detects when the user is having solvency problems, and automatically executes processing to prevent bankruptcy including obtaining general loans; and
automatically detects a simulation resulting in bankruptcy, which is a realistic possibility for all but the wealthiest users.

Hypothetical financial product processing occurs in FIG. 23 as follows. At FIG. 23J, a hypothetical financial product offer is created at step 7320; part of the instance description is that it is a hypothetical offer. Notice of this new product offer is sent to step 6855 of FIG. 23I. At step 6860, financial products database 6027 is updated with the hypothetical financial product offer.

When a new user creates a financial strategy at FIG. 23D1, the hypothetical financial product offer may be included in at least one of the financial product scenarios created at step 6345. It may be selected for the scenario fw* at step 6365. At step 7373, it will be noticed and removed, and at step 7374, the event of its selection is recorded.

For existing users, at step 6865 of FIG. 23I, a notification of the hypothetical financial product offer is sent to existing users. At FIG. 23D1 step 2395, the notice of new product is passed to FIG. 23G and at step 2680, MBFPS 2021 determines that the availability of a new product offer merits evaluating whether a new FS is needed, so processing continues at FIG. 23D1 step 6320. If the hypothetical financial product offer is included in a scenario at step 6345, and then selected at step 6365, the selection event will be recorded at step 7374. Meanwhile, at FIG. 23G, the FS will remain unchanged because the offer is hypothetical.

Turning to FIG. 23K, at step 7460, the financial product provider receives a demand curve for the hypothetical financial product offer including demand from existing and new users. At step S470, the provider may tweak the existing hypothetical offer to create an improved hypothetical financial product offer. At step 7480, its terms are sent to FIG. 23I step 6855, and processing continues as above.

The embodiment of FIG. 23 provides at least the following advantages to a user of financial products:
automatically evaluating financial products for the user's financial plan or financial strategy, i.e., improving financial planning technology, often enables the user to achieve a better life;
an acceptability metric that considers positives and negatives, e.g., RAWM, and an optimality test (e.g., lifetime criteria) improve the suitability of a financial product for the user's life relative to just picking the cheapest financial product among product offers with different terms;
enabling the user to lock-in special financial product deals by determining when they are useful for the user's goals;
automatically choosing the financial product saves the user from a lot of analysis work;
comparing financial strategies based on different financial products, is more meaningful for a user than merely comparing terms of different financial product offers, because obtaining a financial product in isolation is never a user's goal.
accurate modelling of financial products having interest rates that can change at each period, instead of being assumed over the lifetime of the financial product;
better modelling of user preferences, due to the availability of more criteria: benchmarks, priorities, FS periodic acceptability criteria, enabling a MBFPS to automatically find the best FS for a user, reducing the amount of time that the user spends in manually tweaking their FS;
ability to optimize the timing of two goals with respect to each other based on the availability of financial products. automatic asset liquidation to make goals affordable;
better analysis of where to change user inputs for most favorable results;
automatic detection and suggestion of financial product termination opportunities, usually because a better product becomes available, that do not jeopardize goal achievement.

The embodiment of FIG. 23 provides at least the following advantages to a financial product provider:
making the financial product provider's products available via a financial planning system exposes the products to a larger market, specifically, people who lack sufficient numerical literacy and sophistication to know how and when to use financial products;
enabling a financial product provider to be a third-party lender for all users, and/or a supplemental financial product provider for users associated with a financial planning system, lets the financial product provider control its distribution channels;
a financial product provider can better forecast demand by offering lock-in terms (commit now, for use within a predetermined future time range);
financial product demand curves representing aggregate demand spur and/or justify product innovation;
hypothetical financial product offers are an economical way to do market research.

### Use Cases

An actual financial plan is typically about 50 pages long, and is thus too voluminous to provide as a use case. Instead, the following summaries are provided.

For financial products, such as property insurance, a conventional financial planning system expects the user to input an expense payments stream including the property insurance premiums. The FPS does not simulate loss events, rather, one scenario is manually created to show that if a loss event occurs, the financial product provides income to the user.

In contrast, for the present MBFPS, the user simply inputs that property insurance is desired. The MBFPS determines which property insurance products a user is suited for, and simulates their effect on the user's financial strategy. The user can examine a simulation chart such as FIG. 14, and see the property insurance in action. The MBFPS recommends to the user which property insurance to buy, or if the user and insurer have authorized automatic commitment, the MBFPS commits to that insurance for the user.

For bankruptcy, a conventional financial planning system merely indicates that the user had negative terminal wealth in one of the simulation paths. The user then has to determine whether it is a true bankruptcy or a situation that could have been cured by liquidating an asset. In short, a conventional FPS helps the user to detect bankruptcy, but does nothing to prevent it.

In contrast, the present MBFPS prophylactically detects when bankruptcy is likely to occur in a simulation path, then automatically deploys tools—expense reduction, expense elimination, emergency general loan, and/or asset liquidation—to avert the bankruptcy. When a financial strategy is being applied in reality, the MBFPS similarly prophylactically detects when bankruptcy is likely to occur, and deploys tools to prevent the bankruptcy, if possible. In short, the MBFPS prophylatically detects the possibility of bankruptcy and immediately tries to prevent the bankruptcy from occurring.

Although illustrative embodiments of the present invention, and various modifications thereof, have been described in detail herein with reference to the accompanying drawings, it is to be understood that the invention is not limited to these precise embodiments and the described modifications, and that various changes and further modifications may be effected therein by one skilled in the art without departing from the scope or spirit of the invention as defined in the appended claims.

What is claimed is:

1. A method of creating a best financial strategy for a user, the financial strategy showing how at least one goal is affordable based on the user's income, expenses and investment performance, the financial strategy including at least one automatically selected financial product not associated with the at least one goal, comprising:
storing, by a financial planning computer system in a user database, life actions received from the user, the at least one goal received from the user, the goal being an uncommitted life action, user parameters for at least one financial product chosen by the user, parameters for a wellness metric, and parameters for an acceptability test;
storing, by the financial planning computer system in a financial products database, financial product offers from financial product providers, each financial product offer having provider parameters and being independent of the at least one user goal;
creating, by the financial planning computer system, a set of financial product scenarios based on the user parameters and the financial product offers;
for each financial product scenario, generating, by the financial planning computer system, a set of simulations of the user's wealth based on income, expenses, investment performance, goals automatically converted to life actions by the financial planning computer system, and the financial products in the financial product scenario;
selecting, by the financial planning computer system, the best financial product scenario according to the parameters for the wellness metric;
checking, by the financial planning computer system, whether a financial strategy based on the best financial product scenario meets the parameters for the acceptability test; and
when the financial strategy meets the parameters for the acceptability test, storing, by the financial planning computer system, the financial strategy in the user database as the best financial strategy.

2. The method of claim 1, wherein when the financial strategy based on the best financial product scenario does not meet the parameters for the acceptability test, the financing planning computer system automatically:
selects a next-best financial product scenario according to the parameters for the wellness metric,
checks whether a next-best financial strategy based on the next-best financial product scenario meets the parameters for the acceptability test; and
stores the next-best financial strategy in the user database as the best financial strategy when it meets the parameters for the acceptability test.

3. The method of claim 1, wherein, for a financial product scenario fw, a simulation path n, and a time period t, the user's wealth for [fw,n,t] is the sum of:
the user's wealth for an immediately previous time [fw,n,t−1] multiplied by the investment performance,
a net savings for the time period t for all life actions, determined as income less expenses less taxes,
an event cash flow for [fw,n,t] representing an event, if any, outside the control of the user, the event being relevant to a financial product in the financial product scenario fw, and
a financial product cash flow for [fw,n,t].

4. The method of claim 1, further comprising automatically committing the user to the financial product in the best financial strategy when the user and the financial product provider have agreed to automated commitment for the financial product.

5. The method of claim 1, wherein the wellness metric is a probability of achieving the at least one goal reduced by a simulated probability of bankruptcy.

6. The method of claim 1, wherein:
each simulation path in the set of simulations has T time periods,
the set of simulations has N simulation paths, N being at least about 100 to provide realistic statistics,
each goal includes a start time period;
and further comprising:
storing, in the user database, an investment strategy specifying allocation of the user's wealth among V investments;
generating a benchmark based on the goals for each of the T time periods;
and wherein generating the set of simulations includes, for each of the T time periods and each of the N simulation paths:
determining the investment performance of the user's wealth allocated among the V investments; and
converting the goal to a life action affecting the financial simulation when, at the start of the time period, the user's wealth exceeds the benchmark for the time period.

7. The method of claim 6, further comprising generating a solvency threshold for each of the T time periods, and, at each time period T in each simulation path N, checking whether the user's current wealth exceeds the solvency threshold, and when the user's current wealth does not exceed the solvency threshold, taking at least one prophylactic measure to ensure the user's current wealth exceeds the solvency threshold.

8. The method of claim 1, further comprising:
creating an anonymized financial strategy by removing user identifying information from the best financial strategy;
storing the anonymized best financial strategy in a reduced client database; and
generating a financial product demand curve based on the stored anonymized best financial strategies.

9. The method of claim 8, further comprising
sending the financial product demand curve to at least one of the financial product providers;
receiving, from at least one of the financial product providers, an improved financial product offer; and
automatically determining whether the best financial strategy should be revised to include the improved financial product offer.

10. The method of claim 1, wherein at least one of the stored financial product offers is a hypothetical offer; and
further comprising recording when the hypothetical financial product offer is selected for the best financial strategy.

11. The method of claim 10, further comprising generating a hypothetical financial product demand curve based on the recorded selections of hypothetical financial product offers.

12. A method of creating a best financial strategy for a user that automatically determines when a user's expenses are excessive relative to the user's income and automatically tries to prevent bankruptcy, comprising:
receiving, at a financial planning system, information for a user including income, expenses, investment strategy and assets;
simulating, by the financial planning system, a user's current wealth for N simulation paths based on the user's income, expenses, and investment strategy, each simulation path having T time periods, N being at least 100 and T being at least 60;
at each time period of each simulation path, determining, by the financial planning system, whether the user's current wealth exceeds a solvency threshold;
when the user's current wealth is less than the solvency threshold, automatically taking, by the financial planning system, a prophylactic measure so that the user's current wealth exceeds the solvency threshold;
determining, by the financial planning system, whether the simulations result in the best financial strategy using a metric; and
storing, by the financial planning system, the best financial strategy.

13. The method of claim 12, wherein the prophylactic measure is at least one of reducing expenses, eliminating expenses, obtaining a loan, and liquidating assets.

14. The method of claim 12, further comprising:
receiving, at the financial planning system, at least one goal for the user;
determining a benchmark so that the user's wealth is zero at death;
including the goal as a life action in a simulation path when the user's current wealth exceeds the benchmark, and
wherein the prophylactic measure is adjusting the included goal to reduce expenses.

15. The method of claim 12, further comprising:
receiving, at the financial planning system, at least one goal for the user;
determining a benchmark so that the user's wealth is zero at death;
including the goal as a life action in a simulation path when the user's current wealth exceeds the benchmark, and
wherein the prophylactic measure is excluding the included goal to eliminate expenses.

16. The method of claim 12, wherein the prophylactic measure includes:
determining loans that the user is eligible for,
creating a set of general loan scenarios corresponding to combinations of loans that the user is eligible for,
evaluating each of the general loan scenarios to see if the loan amounts permit the user's current wealth to exceed the solvency threshold, and
selecting the cheapest of the general loan scenarios that permit the user's current wealth to exceed the solvency threshold.

17. The method of claim 12, further comprising:
declaring a bankruptcy event for a simulation path when the user's current wealth is below the solvency threshold, and
determining the probability of bankruptcy as the number of simulation paths with a bankruptcy event divided by the total number of simulation paths.

18. The method of claim 17, further comprising:
receiving, at the financial planning system, at least one goal for the user;
determining a benchmark so that the user's wealth is zero at death;
including the goal as a life action in a simulation path when the user's current wealth exceeds the benchmark, and
wherein the metric is the probability of achieving the goal in the set of simulations reduced by the probability of bankruptcy.
